(19) United States
(12) Patent Application Publication
(10) Pub. No.: US 2025/0250165 A1
(43) Pub. Date: Aug. 7, 2025

(54) CATALYTIC PRODUCTION OF HYDROGEN FROM WATER

(71) Applicants: DREXEL UNIVERSITY, Philadelphia, PA (US); NATIONAL INSTITUTE OF MATERIALS PHYSICS, Ilfov (RO)

(72) Inventors: Michel W. BARSOUM, Moorestown, NJ (US); Mihaela FLOREA, Bucharest (RO); Stefan NEATU, Ilfov (RO)

(21) Appl. No.: 18/856,099

(22) PCT Filed: Apr. 13, 2023
(86) PCT No.: PCT/US2023/065725

§ 371 Date: Oct. 11, 2024

Related U.S. Application Data
(60) Provisional application No. 63/330,733, filed on Apr. 13, 2022.

(51) Int. Cl. C01B 3/04

(52) U.S. Cl. CPC C01B 3/042; C01B 2203/0277; C01B 2203/10; C01B 2203/1223

(57) ABSTRACT

Processes of photocatalytically generating molecular hydrogen (H₂) and systems for carrying out the processes. Liquid water is contacted with an amount of a ID and/or 2D carbon-doped nanofilament-based photocatalyst material composition and a hole scavenger chemical, optionally under an inert gas purge, at temperature of 100° C. or less, generating gaseous molecular hydrogen by irradiating the liquid water, the hole scavenger chemical, and the photocatalyst for about 1 to 300 hours with at least one sun illumination (UV-Vis light (250-650 nm)).

### CROSS REFERENCE TO RELATED APPLICATIONS

The present application claims priority to and the benefit of U.S. patent application No. 63/330,733, “Catalytic Production of Hydrogen From Water” (filed Apr. 13, 2022). All foregoing applications are incorporated herein by reference in their entireties for any and all purposes.

### TECHNICAL FIELD

The present disclosure relates generally to the field of hydrogen and processes of generating same from water, and using same, and more specifically to compositions, apparatus, systems, and processes of generation of hydrogen using catalysis.

### BACKGROUND

Hydrogen, hydrogen production processes, and hydrogen as fuel for vehicles using fuel cells are widely studied topics. Two areas of research in hydrogen production are PEM (proton exchange membrane) electrolysis of water and SOE (solid oxide electrolysis). The primary cost driver in both processes is electricity. Lowering the demand of electricity in production of hydrogen from water is desired. These systems also operate at relatively high temperatures ranging from 150 to 800° C., especially SOE systems. See, for example, U.S. Pat. No. 8,945,356, where temperatures exceed 450° C., typically between 600° C. and 1,000° C. Photocatalysis can be used to convert water into hydrogen, a clean option to traditional fossil fuels.

Despite significant progress, inexpensive photocatalysts that are stable for extended periods of time have yet to be discovered. At the current cost of ≈$10/kg of H₂, this process is too expensive, with the highest contribution coming from the cost of the photocatalyst itself. In the photocatalytic process, a photocatalyst is exposed to sunlight in the presence of water, that in turn decomposes the water into H₂ and oxygen, O₂, according to the following reaction (Fujishima et al.):

2H₂O+sunlight→2H₂+O₂ ΔG=237 KJ mol⁻¹ (1)

During this process, the light creates electron-hole pairs that need to produce H₂ before they recombine. A common method to do so is to add hole scavengers, like methanol or glycerol, to the water. These scavengers rapidly consume the holes, allowing the electrons to produce H₂ while changing the chemical nature of the scavengers. Quite recently we reported on a simple, inexpensive, one pot, scalable method to convert over ten, water insoluble Ti-containing compounds, including inexpensive binary carbides and borides, (TiC, TiN, TiB₂, and the like) into nanofilaments (“NFs”) with cross-sections of the order of, sub-nanometer, for example, about 6×10 Å². (Badr, H. et al., “Bottom-up, scalable synthesis of anatase nanofilament-based two-dimensional titanium carbo-oxide flakes”, Mater. Today; PCT patent application No. PCT/US2022/070644, filed Feb. 11, 2022); and Badr. et al., Matter 6, 1-14 (January 2023).

It would be an advance in the field of hydrogen generation from water to develop materials, apparatus, systems, and processes, that exhibit improvements related to cost, either in energy efficiency, starting materials, or both, particularly for sourcing hydrogen from water using catalysts derived from relatively low cost, normally solid chemical compositions.

### SUMMARY

In accordance with the present disclosure, materials, apparatus, systems, and processes for production of hydrogen (H₂) from water are described which reduce or overcome one or more of the shortcomings of previously known hydrogen production processes and systems. Herein we describe producing H₂ using 1D and/or 2D (which can be p-2D) nanofilament-based catalyst (which can, optionally, be carbon-doped or carbon-comprising) that can be stable in water for times of at least about 5000 hours—at least about 300 hours of which were under one sun illumination, which can be characterized as ultrastable. The nanocatalyst can be, for example, 1D titania-based nanofilaments that can self-assemble into pseudo-2D sheets (p-2D). Such materials can be termed, for example, 1D/2D. The process to make them is massively scalable, and the starting raw materials, for example TiC or TiB₂, are cheap, and abundant. For example, in water/methanol mixtures, 800 μmol H₂ g⁻¹ h⁻¹ were produced under 2 suns illumination. In certain embodiments, glycerol, an abundant side product from biodiesel production, can be used to produce hydrogen. In another example, using water/glycerol mixtures, the rate was 300 μmol H₂ g⁻¹ h⁻¹. The present disclosure describes new processes for using cheap and ultrastable (as described herein) photocatalytic materials to convert water and one or more hole scavengers (such as glycerol) to hydrogen. When methanol is the scavenger, no other gases are generated, for long periods of time.

A first aspect of the present disclosure is processes for photocatalytically generating molecular hydrogen (H₂) comprising (or consisting essentially of, or consisting of):
a) contacting a 1D and/or 2D (which can be p-2D) carbon-doped nanofilament-based photocatalyst, optionally carbon-doped or carbon-comprising) (which can also be anatase-based but need not be and which can be anatase-based but need not be; which can also exhibit one or more anatase characteristics but need not necessarily do so; which can also exhibit one or more lepidocrocite characteristics but need not necessarily do so) with water and a hole scavenger chemical at a mole ratio of water to hole scavenger chemical ranging from about 2:1 to about 6:1, at a temperature less than about 100° C., optionally at a pressure ranging from about 1 to about 5 bar; and
b) irradiating the photocatalyst, the water, and the hole scavenger chemical (optionally for about 1 to about 300 hours) with at least one sun illumination (UV-Vis light (250-650 nm)), thus photocatalytically generating the molecular hydrogen.

A second aspect of the present disclosure are gaseous compositions prepared according to the processes of the present disclosure.

Processes of using one or more hydrogen-rich compositions of the present disclosure are also presented, such as feeding a hydrogen or hydrogen-rich composition directly or indirectly (in other words, to intermediate storage) to one or more fuel cells for producing electricity. Oxygen, or oxygen-rich compositions can be employed in combustion processes or can be combusted with hydrogen to produce water.

Processes, apparatus, systems, and compositions of the present disclosure will become more apparent upon review of the brief description of the drawings, the detailed description of the disclosure, and the claims that follow.

### BRIEF DESCRIPTION OF THE DRAWINGS

FIG. 1 is a schematic process flow diagram of one process and system embodiment in accordance with the present disclosure;

FIGS. 2A and 2B are schematic illustration elevation and plan views, respectively, of a process and system for generating H₂ using a simple refillable pond;

FIG. 3 is a more detailed schematic process flow diagram of another process and system embodiment in accordance with the present disclosure;

FIG. 4 provides cumulative H₂ yield as a function of time, with different illumination levels.

FIG. 5 provides cumulative H₂ yield for TiOC (which can also be termed TiCO)—first run, as a function of time. A photocatalyst material according to the present disclosure can be, for example, TiO₂ with carbon terminations.

FIG. 6 provides cumulative H₂ yield for TiOC-first run, as a function of time (1 sun).

FIG. 7 provides cumulative H₂ yield for TiOC-first run, as a function of time. (2 suns).

FIGS. 8A-8C provide x-ray diffraction patterns for TiCO1_LiCl, TiCO1_EtOH, and TiCO3 before and after irradiation. (As mentioned elsewhere herein, TiCO can also be termed TiOC, and vice versa.) The patterns correspond to the same material, which after designated reaction times is extracted from the photoreactor, dried, and characterized by XRD.

FIGS. 9A-9C provide transformed Kubelka-Munk function vs. energy of the absorbed light for TiCO photocatalysts before and after reaction.

FIGS. 10A-10C provide XPS spectra of TCO samples.

FIGS. 11A-11B provide (11A) High resolution XPS spectra of the valence band region for TiCOl_LiCl fresh (red line) and after reaction (blue line). For comparison, the starting material is also represented (green line). (11B): HR-XPS spectra of the valence band for TiCOl_EtOH fresh (blue line) and after reaction (red line).

FIGS. 12A-12B provide XPS spectra of used precursors in the C1s region.

FIGS. 13A-13F provide HR-XPS spectra of TiCO in the C1s region taken before and after reaction.

FIGS. 14A-14B provide HR-XPS spectra of precursors in the Ti 2P region.

FIG. 14C provides HR-XPS spectrum of Ti₃SiC₂ precursors in the O 1s region.

FIGS. 15A-15F provide HR-XPS spectra of TiCO in the Ti 2p region taken before and after reaction.

FIGS. 16A-16F provide HR-XPS spectra of TiCO in the O 1s region taken before and after reaction.

FIGS. 17A-17E provide HR-XPS spectra of TiCO in the Si 2p region taken before and after reaction.

FIGS. 18A-18D provide HR-XPS spectra of TiCO 1 samples in the N 1s region taken after reaction and after Ar⁺ sputtering.

FIG. 19 provides time course of the water splitting reaction on TiCOl photocatalyst in the presence of methanol as hole scavenger. Reaction conditions: 0.025 g of photocatalyst dispersed in 25 ml solution (mixture of deionized water and methanol in a volumetric ratio of 4:1); irradiation with a MAX-303 illuminator (Asahi Spectra) with UV-Vis mirror module (250-650 nm); irradiance power: 200 mW/cm².

FIG. 20 provides cyclic tests for H₂ generation through water splitting reaction on TiCO1 photocatalyst. Reaction conditions: 0.025 g of photocatalyst dispersed in 25 ml solution (mixture of deionized water and methanol in a volumetric ratio of 4:1); irradiation source: MAX-303 illuminator (Asahi Spectra) with UV-Vis mirror module (250-650 nm); irradiance power: 200 mW/cm²; reaction time per each cycle: 14 hours.

FIG. 21 provides EPR spectra of the TiCO samples.

FIGS. 22A-22C provide exemplary, non-limiting date from the disclosed technology.

FIGS. 23A-23C provide exemplary, non-limiting date from the disclosed technology.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

Moreover, the use of negative limitations is specifically contemplated; for example, certain compositions, apparatus, systems, and processes can comprise a number of physical components and features, but can be devoid of certain optional hardware and/or other features. For example, certain gaseous composition embodiments can be devoid of carbonated gases, such as CO, CO₂, and CH₄. Certain other apparatus embodiments can comprise reactors devoid of any gaskets or O-rings. In certain embodiments the catalyst material can be devoid of anything but 1D nanofilaments. As used in the present disclosure, materials with one dimension much larger than the other two dimensions are called one-dimensional. The nanofilament cross-section can be sub-nanometer, e.g., about 5×7 Å². The cross-section can be, about 60 Å²; the length can be from about 1-10 microns in some cases. The materials are referred to as 2D (which can be p-2D) when one of the other dimensions becomes also in the micron range.

All published patent applications, patents, and publications referenced herein are hereby explicitly incorporated herein by reference. In the event definitions of terms in the referenced patents and applications conflict with how those terms are defined in the present application, the definitions for those terms that are provided in the present application shall be deemed controlling.

As explained elsewhere herein, the primary cost driver in most known processes of generating hydrogen from water is cost of electricity. Lowering the demand of electricity in production of hydrogen from water is desired. It is also desirous to reduce cost of raw materials used to produce active catalysts for generation of hydrogen from water. It would be an advanced in the field of hydrogen generation to develop materials, apparatus, systems, and processes, that exhibit improvements related to cost, either in energy efficiency, starting materials, or both, particularly for sourcing hydrogen from normally solid chemical compositions.

The following aspects and embodiments thereof are illustrative only and do not limit the scope of the present disclosure or the appended claims.

A first aspect of this disclosure are processes for photocatalytically generating molecular hydrogen (H₂) comprising (or consisting essentially of, or consisting of):
a) contacting a 1D/2D nanofilament-based photocatalyst (which can optionally be carbon-doped or carbon-comprising) with water and a hole scavenger chemical at a mole ratio of water to hole scavenger chemical ranging from about 2:1 to about 6:1, at a temperature less than about 100° C., optionally at a pressure ranging from about 1 to about 5 bar; and
b) irradiating the photocatalyst, the water, and the hole scavenger chemical (optionally for about 1 to about 300 hours) with at least one sun illumination (UV-Vis light (250-650 nm)), thus photocatalytically generating the molecular hydrogen.

As a shorthand notation, the 1D/2D nanofilament-based photocatalyst and/or the 2D (which can be p-2D) flakes can be referred to as “TCO”, or in some of the Tables and Figures as “TICO”. In certain embodiments, 1D nanofilaments (which can, again, be carbon-doped or carbon-comprising) self-assemble, forming a plethora of structures depending on how the nanofilaments are washed. Two-dimensional material is a special case in which the nanofilaments assemble in 2D (which can be p-2D) layers. In certain non-exclusive embodiments the nanofilaments can consist essentially of C-doped TiO₂. In certain embodiments the Ti, O, and C atoms can be present in the TCO in about a 1:1:1 atomic ratio.

The hydrogen (H₂) production step in processes of the present disclosure can be carried out at temperatures ranging from about 0° C. or to about 100° C., or from about 10° C. to about 40° C., or from about 15° C. to about 25° C.

The hydrogen production step in certain processes of the present disclosure can be carried out at pressures ranging from sub-atmospheric to above atmospheric, or from vacuum or near-vacuum pressure to several bar, or from atmospheric pressure to 10 bar, or from about 1 bar to about 5 bar.

Various terms are used throughout this disclosure. The photocatalyst material composition can, in non-limiting embodiments, comprise C-doped nanofilaments having a cross-sectional area ranging from about 5 to about 120 Å², or from about 10 to about 80 Å², or from about 20 to about 70 Å². As described elsewhere herein, the nanofilaments can optionally be carbon-doped or otherwise carbon-comprising. The nanofilaments can also have a sub-nanometer cross-section.

The production of the 1D and/or 2D (which can be p-2D) nanofilaments are described in detail in co-pending applications and other documents referenced herein (including Badr. et al., Matter 6, 1-14 (January 2023)), all incorporated herein by reference, and is summarized here for completeness. The 1D and/or 2D (which can be p-2D) nanofilaments can be derived from binary materials. The binary material can be, for example, but to limited to TiC, TiB₂, TiN, Ti₃Si₃, TiAl₃, TiAl, Ti₃Al, TiP, and any combinations and mixtures thereof. Suitable other photocatalyst precursor materials can be ternary Ti-containing materials. The ternary Ti-containing material can be, for example, but not limited to Ti₃AlC₂, Ti₃SiC₂, Ti₃GaC₂, Ti₃ZnC₂, Ti₃CuC₂, Ti₂SbP, and combinations and mixtures thereof. Yet other suitable photocatalyst precursor materials include ternary and quaternary MAX-phase materials.

Methods of making the 1D and/or 2D (which can be p-2D) nanofilament-based photocatalysts can comprise contacting a Ti-containing material with a quaternary ammonium salt and/or base, in certain embodiments the temperature and pressure can be at ambient or near ambient, and the time of the reaction in certain embodiments can be for a few days. In certain embodiments the temperature can range from about 0° C. to about 100° C., and the time of the reaction can be for about 1 to about 7 days. In certain embodiments the Ti-containing material can be a mono-, binary, ternary, or higher carbide, boride, nitride, silicide, aluminide, phosphide or other titanium-containing powder, or mixture or combination thereof.

In certain embodiments the quaternary ammonium compound can comprise an ammonium hydroxide, an ammonium halide, or any mixture or combination thereof. In certain embodiments the quaternary ammonium compound can be selected from tetramethylammonium hydroxide (TMAH), tetraethylammonium hydroxide (TEAH), tetrapropylammonium hydroxide (TPAH), tetrabutylammonium hydroxide (TBAH), ammonium hydroxide (NH₄H), their amine derivatives, or any mixture or combination thereof.

In certain embodiments the quaternary ammonium salt can be selected from quaternary ammonium chlorides, quaternary ammonium bromides, quaternary ammonium iodides, quaternary ammonium fluorides, or any mixture or combination thereof.

In certain embodiments the product of contacting a Ti-containing material with a quaternary ammonium salt and/or base can further comprise washing the product with one or more alcohols, one or more metal salts, and/or any water-soluble metal compound. The metal salt can be selected from metal halide salts, for example Li halide salts, Na halide salts, K halide salts, Rb halide salts, Cs halide salts, Fr halide salts, Be halide salts, Mg halide salts, Ca halide salts, Sr halide salts, Ba halide salts, Ra halide salts, Mn halide salts, Fe halide salts, Ni halide salts, Co halide salts, Cu halide salts, Zn halide salts, Mo halide salts, Nb halide salts, W halide salts, or any mixture or combination thereof.

In certain embodiments the metal salt can further comprise one or more metal sulfates, one or more metal nitrates, one or more metal chromates, one or more metal acetates, one or more metal carbonates, one or more metal permanganates, and/or one or more metal hydroxides, or any mixture or combination of thereof.

In certain embodiments the metal in the metal salt can be selected from essentially any metal from the periodic table, for example, but not limited to, Li, Na, K, Mg, Ca, Cr, Mn, Fe, Co, Ni, Cu, Zn, Nb, Mo, Cd, Ta, or W, or any mixture or combination of thereof. In certain embodiments the metal salt can be, for example, but not limited to, LiCl, KCl, NaCl, LiF, KF, NaF, LiOH, KOH, NaOH, or any mixture or combination thereof. In certain embodiments the metal salt can comprise CrCl₃, MnCl₂, FeCl₂, FeCl₃, CoCl₂, NiCl₂, MoCl₅, FeSO₄, (NH₄)₂Fe(SO₄)₂, CuCl₂, CuCl, ZnCl₂, or any mixture or combination thereof.

Water functions as the source of hydrogen. Well water, rain water, river water, lake water, pond water, ground water, or any mixture or combination thereof can be appropriate. In certain embodiments the water can be deionized water. For experimental purposes we used deionized water produced by the purification system known under the trade designation MILLI-Q, available from MilliporeSigma, especially deionized water having Type 1 properties: Resistivity >18 MOhms-cm @ 25° C.; total organic carbon <10 ppb; pyrogens <0.03 EU/mL; particulates >0.2 microns <1 units/mL; colloids <10 ppb (silica); and bacteria <1 cfu/mL).

Hole scavengers function to prevent rapid recombination of photogenerated electron-hole pairs. As the photocatalytic evolution of hydrogen (H₂) is driven by the photogenerated electrons, a fast removal of photogenerated holes from the photocatalyst is preferred to suppress recombination. The efficiency of hydrogen generation can be increased using hole scavengers. Suitable hole scavengers for use in the processes of the present disclosure include inorganic and organic hole scavengers. Suitable organic hole scavengers include, but are not limited to, methanol, isopropanol, glycerol and other low molecular weight polyols, ethylene glycol and EDTA-Na₂.

In certain embodiments, the sun or other natural irradiation functions as the irradiation source, and it can be unaltered in direction or reflected from one or more objects such as mirrors. The sunlight can be refracted around an object. Portions of the sun's spectrum can be used. In the Examples herein, to simulate the sun, we used a 300 W xenon light source having a UV-vis mirror module, equipped with a one-meter-long quartz light guide and a collimator lens×1.0 (STD) Type RLQL80-1 that assures a uniform 2 suns illumination (an irradiance of 200 mW/cm²) at a working distance of 8 cm.

Suitable reactors for use in processes of the present disclosure can be continuous, semi-continuous, batch or semi-batch reactors. Glass or glass-lined steel (or PTFE, or PFA, or tantalum) reactors can be used in certain embodiments, with the proviso that if glass-lined reactors are employed for the photocatalytic reactor (sometimes referred to herein as the second reactor), there remains sufficient transparency to allow sufficient “sun light” (either natural or artificial, or both) to reach the reacting compositions. For example, a glass-lined steel reactor can have a plurality of glass windows, a full or partial glass roof, and/or a full or partial glass bottom., where the glass windows comprise a majority of the vessel, and the balance is steel. Glass is preferred as allowing irradiation by the lamp or lamps, or the sun itself, or both lamps and the sun in certain embodiments. The reactor volumes can range from lab-scale (50 mL) up to commercial scale (10,000 L or more), and can include accessories, for example, but not limited to, pressure and temperature measurement devices, agitation devices, motors for running the agitators, one or more inlets and outlets for inert gas purging, one or more outlets for mixture of generated H₂/O₂, heating and cooling facilities, timers, and one or more human/machine interfaces (HMIs). Certain reactors can include one or more process controllers, pressure relief valves, accessways for human or non-human inspection, sampling ports, pH probes, and the like. Suitable reactors should have the capability to withstand temperatures up to 200° C. and up to 5 bar pressure for up to 250 hours or more.

Examples of suitable inert gases include, but are not limited to, nitrogen, argon, xenon, krypton, and mixtures thereof. The sources of inert gases can be one or more conduits, pipelines, storage facilities, or cylinders. Inert gases can be supplied from a pipeline, cylinder, storage facility, cryogenic separation unit, membrane permeation separator, or adsorption unit such as a vacuum swing adsorption unit.

In certain embodiments, the reactor can be pressurized to a pressure ranging from about 1 to about 5 bar or from about 1 to about 3 bar, or from 1 to about 2 bar) with an inert gas and irradiated from about 1 to about 300 hrs. (or from about 1 to about 200 hrs., or from about 1 to about 150 hrs., or from about 1 to about 100 hrs.) with UV-vis light having a wavelength ranging from about 250 to about 650 nm (or from about 250 to about 500 nm, or from about 300 to about 650 nm). The reactor can operate at ambient temperature, room temperature, or other temperature up to about 150° C. Without being bound to any particular theory, operating at too high a temperature can evaporate water too quickly, while operating at too low temperature can result in ice formation, both of which are not desired. In remote regions where inert gas is not available, the reaction can proceed under an air atmosphere enriched in generated H₂.

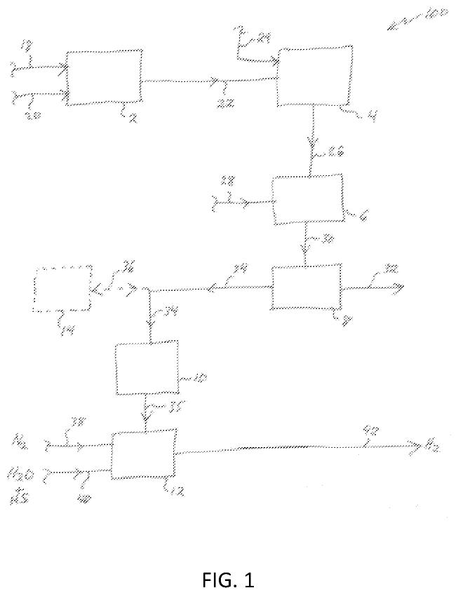

Referring now to the figures, FIG. 1 is a high-level schematic process flow diagram of one process and system embodiment 100 in accordance with the present disclosure, including a first reactor 2, an organic solvent washer 4, a precipitator 6, a filter 8, a solids handling device 10, and a second reactor 12. In certain embodiments the precipitator and filter can be combined as a unit. Moreover, solvent washing can be performed in first reactor 2. An optional storage container 14 and an optional separator 16 are illustrated. A first photocatalyst precursor material 18 (for example Ti₃SiC₂, as described in the Examples herein) is routed to first reactor 2, and an onium salt solution as well, 20. First reactor 2 produces a second photocatalyst precursor material 22 which is routed to an organic solvent washer 4, as is an organic solvent 24. From organic solvent washer 4, a clean second photocatalyst precursor material 26 is produced which is routed to precipitator 6, optionally along with an inorganic salt precipitator solution 28 (for example a 1 M aqueous solution of LiCl). Precipitator 6 produces a colloidal photocatalytic precursor material 30 that is then routed to filter 8, where waste liquids are removed (at 32) and a photocatalyst precursor film 34 is produced, which optionally can be routed via conduit 36 to storage container 14 or routed to solids handling equipment 10 to produce a photocatalyst material composition powder 35 in this embodiment 100. Photocatalyst material composition 35 is routed to second reactor 12 where it is contacted with a mixture of water and a hole scavenger (HS) 40. Second reactor 12 is nitrogen purged and then pressured to pressure ranging from about 1 to 5 bar with nitrogen at room temperature, or whatever the ambient temperature is, generating an exhaust stream 42 of H₂. The H₂ can be directed to a downstream use, or storage.

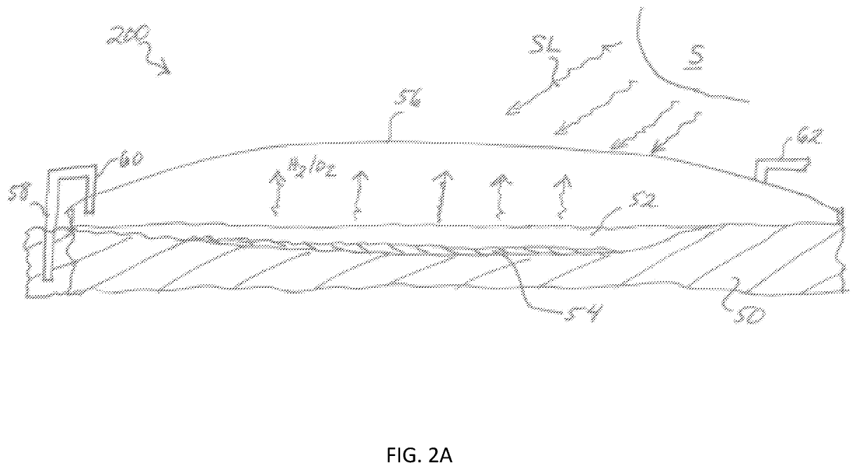

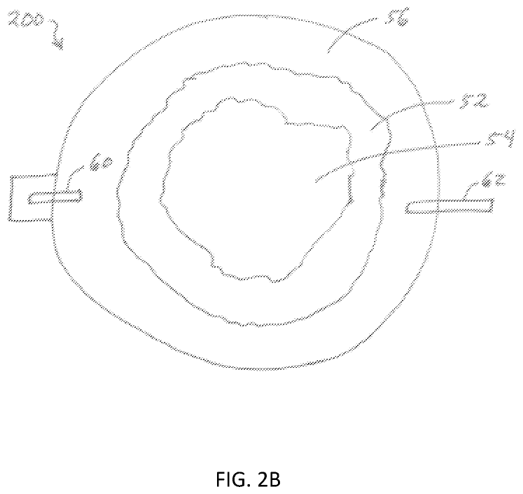

FIGS. 2A and 2B are schematic illustration elevation and plan views, respectively, of a process and system embodiment 200 for generating H₂ using a simple refillable pond of water, as can be the case in remote areas, or when electricity is not available and a source of hydrogen. Embodiment 200 features a pond a water 52 in the earth 50, with a supply of photocatalyst material composition 54 lining or otherwise placed in the bottom of the pond. The sun is illustrated at “S”, with rays of sunlight indicated schematically as “SL”. A transparent cover 56 (glass or polymeric) allows sunlight SL to reach areas in the pond where water 52 and photocatalyst material composition 54 are in contact. For this reason, the pond depth must remain relatively shallow as local conditions allow. A water well 58 and water supply conduit 60 are illustrated to fill and refill the pond, and an exhaust conduit 62 allows H₂ to be routed where needed.

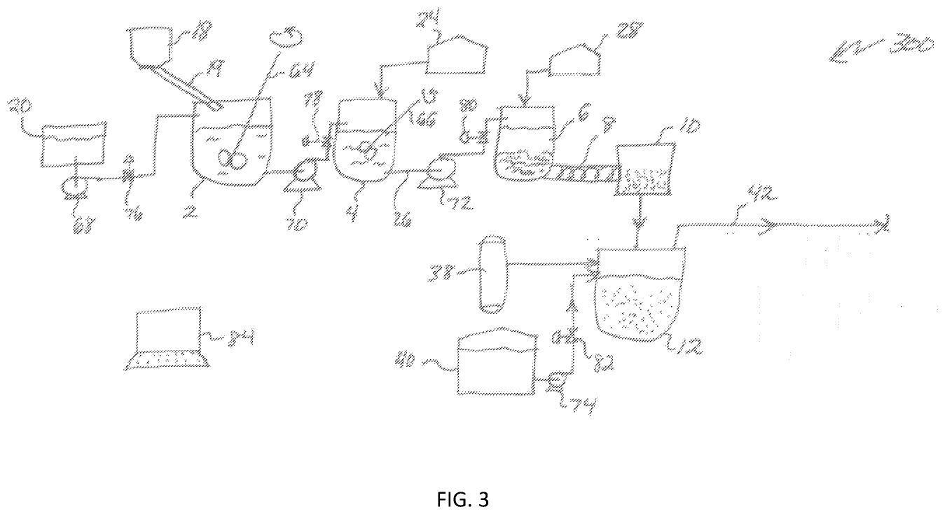

FIG. 3 is a more detailed schematic process flow diagram of another process and system embodiment 300 in accordance with the present disclosure. Embodiment 300 differs from embodiment 100 in that stirrers or agitators 64, 66 are included in first reactor 2 and organic solvent washer 4, respectively, as well as various pumps and control valves, and a chute 19 for transfer of solid first photocatalyst precursor material into first reactor 2. Pump 68 transfers an aqueous onium solution 20 to first reactor 2; pump 70 transfers second photocatalyst precursor from first reactor 2 to organic solvent washer 4; pump 72 transfers clean second photocatalyst precursor from organic solvent washer 4 to precipitator 6; and pump 74 transfers a mixture of water and hole scavenger 40 to second reactor 12. A series of control valves 76, 78, 80, and 82 control flows from pumps 68, 70, 72, and 82, respectively, controlled by one or more supervisory controllers 84 (such as a supervisory computer) that can operate via wired or wireless control signals to operate the control valves, pumps, agitators, and other equipment. It will be understood by those skilled in the chemical processing arts that many variations of embodiment 300 are possible. Furthermore, many sensors are not displayed that would be included in certain industrial embodiments, such as mass flow sensors or meters, temperature sensors, pressure sensors, pH sensors, weight sensors, and the like. One or more of these sensors or meters could be controllers as well, such as temperature-indicating-controllers, pressure-indicating controllers, and the like. These sensors are not illustrated in FIG. 3 for brevity.

Thus the systems and processes described herein and equivalents thereof afford ways to produce hydrogen photocatalytically from water safely and economically from a sustainable source (sunlight or its equivalent). The following Examples can further assist in understanding certain aspects of the systems and processes of this disclosure.

### EXAMPLES

Example 1. Performance of the photocatalytic water splitting reaction in the presence of Ti₃SiC₂-derived TCO under 1 sun irradiation and in the presence of methanol as hole scavenger.

Part A. The photocatalyst Ti₃SiC₂-derived TCO sample was produced by treating the ternary precursor Ti₃SiC₂ powder in TMAH at 50° C. for 5 days. This sample was washed with ethanol then LiCl solution and the colloid filtered to form a film. The film was then gently crushed in a mortar and pestle to make a powder form of the photocatalytic material.

All chemicals were used without further purification. Deionized water produced using a system known under the trade designation MILLI-Q (available from MilliporeSigma in the United States) was used in all stages of preparation.

Part B. The Ti₃SiC₂-derived TCO powder photocatalytic material was used, according to the present disclosure, in the water splitting reaction to generate H₂ from water under 1 sun irradiation and in the presence of a hole scavenger, as follows:

To perform the water splitting reaction, a measured amount of the solid sample of Ti₃SiC₂-derived TCO produced in Part A (between 10 and 100 mg) was immersed into a cylindrical quartz reactor (total volume of 55 mL) containing 25 mL of a mixture of water and methanol (purity ≥99.9%) under a volumetric ratio between water and methanol from 3:1 to 5:1, and under sufficient agitation to form suspensions. The reactor was equipped with two gas valves and a pressure gauge. The suspensions were purged with dry nitrogen (99.999% nitrogen, available commercially from Linde under the trade designation 5.0 Linde) for 10 to 30 minutes and then the reactor was pressurized (pressures from 1 to 5 bar) and irradiated with radiation from 1 to 30 hrs. with UV-Vis light (250-650 nm) provided by a photocatalytic setup, which was a high-power illuminator known under the trade designation MAX-303 (available from Asahi Spectra) with heat blocking design containing a 300 W xenon light source and a UV-vis mirror module, equipped with a one-meter-long quartz light guide and a collimator lens×1.0 (STD) Type RLQL80-1 that assured a uniform 2 suns illumination (an irradiance of 200 mW/cm²) at a working distance of 8 cm. To perform the reactions at only 1 sun illumination (100 mW/cm²), the light intensity was adjusted by using the unit neutral density filter variable controller.

The photocatalytic gaseous product H₂ was taken from an outlet valve of the reactor and injected into a Shimadzu gas chromatograph (GC) coupled on-line with the photocatalytic reactor, equipped with a thermal conductivity detector (TCD) for the quantification of H₂. Two serial-coupled GC columns, the first being a MolSieve 5A (column length of 30 m and ID of 0.32 mm) and the second being a column known under the trade designation RT-Q-BOND (available from Restek, State College, Pennsylvania) (a porous layer open tubular (PLOT) column having a column length of 30 m and ID of 0.53 mm) were used. The GC calibration was made by injecting mixtures of H₂ in Ar (Linde) with known proportions. Several other blank experiments were performed in order to prove that the H₂ production came from the water splitting process only. Reproducibility of the data was checked by performing independent experiments in duplicate, by which consistent results were obtained with significantly lower dispersions (smaller than 5%). In none of the experiments was any gas other than H₂ generated.

The temporal evolution of H₂ production over long-time irradiation time (between 30 to 300 hrs.) was performed using the same setup, quantities of reaction mixture (25 mL of water and methanol with a volumetric ratio of 4:1) and solid Ti₃SiC₂-derived TCO materials (25 mg) and following the same procedure described above for the detection of the evolved H₂ gas. After designated reaction times, the entire gas content of the reactor was injected into the GC for H₂ quantification and then the reactor was re-pressurized (pressures between 1 to 5 bar) with dry nitrogen, N₂.

The photocatalytic performance is expressed in micromoles of H₂ formed per unit time (hour) per unit mass (gram) of photocatalytic material. Under the reaction conditions presented above, in this Example 1, the photocatalytic performance was between 10 and 1000 micromoles of H₂ formed per hour per gram of photocatalytic material.

Examples 2-4. Performance of the photocatalytic water splitting reaction in the presence of Ti₃SiC₂-derived material under 2 suns irradiation and in the presence of methanol as hole scavenger. Comparative Examples 5-7. Performance of water splitting reaction in the presence of commercial TiO₂ photocatalysts under the same conditions.

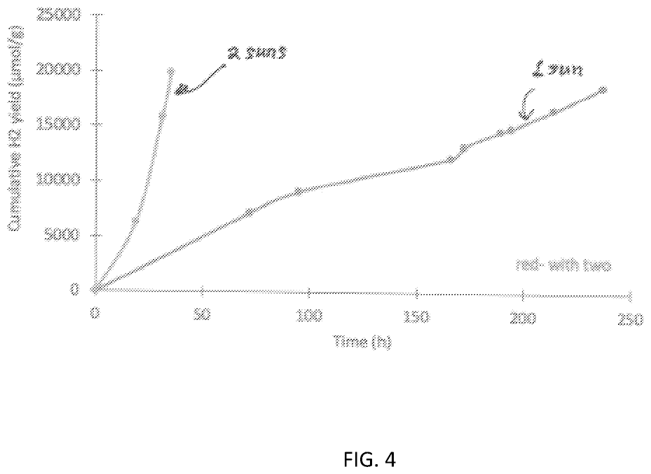

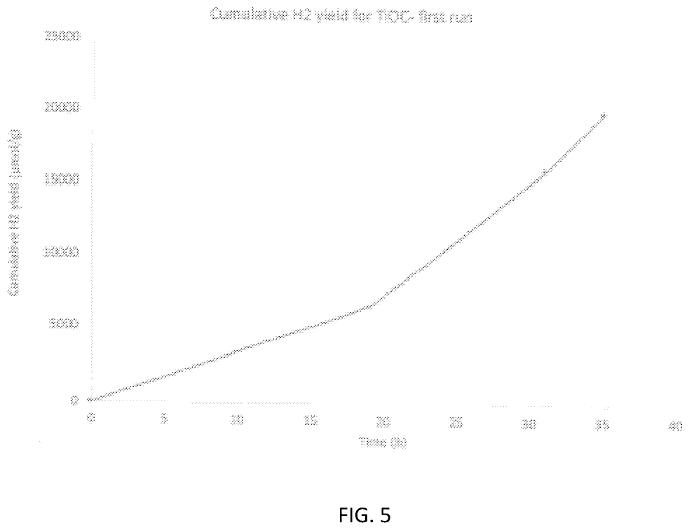

The photocatalytic materials whose synthesis procedure was described above in Example 1 were used, in the water splitting process under 2 suns irradiation and in the presence of methanol as hole scavenger. The results are shown in FIGS. 4-7, and summarized in Tables 1 and 2. The H:O ratio was 2:1 indicating that the methanol was not participating in the reaction.

TABLE 1
Photocatalytic water splitting performance of different Ti₃SiC₂-derived
TCO materials as compared to other commercial TiO₂ photocatalysts.

| | | H₂ production | |
|---|---|---|---|
| Example | Photocatalyst | (micromol/gh) | Obs. |
| 2 | Ti₃SiC₂-derived TCO | 20.12 | After 5.5 h in water and |
| | (overall water splitting - | | irradiation, 2.8 bar of N₂, |
| | reaction performed | | RT |
| | without methanol as hole | | |
| | scavenger) | | |
| 3 | Ti₃SiC₂-derived TCO* | 199.24 | After 30 h in water and |
| | with methanol | | 5.5 h of irradiation; 2.8 |
| | | | bar of N₂, RT |
| 4 | Ti₃SiC₂-derived TCO | 568.85 | After 100 h in water and |
| | with methanol | | 35 h of irradiation, 3.1 bar |
| | | | of N₂, RT |
| 5 | TiO₂ Degussa | 178.85 | After 3 h in water and |
| (comparative) | (commercial) with | | irradiation, 2.1 bar of N₂, |
| | methanol | | RT |
| 6 | TiO₂ anatase | 0 | After 4 h in water and |
| (comparative) | (commercial) with | | irradiation, 3 bar of N₂, |
| | methanol | | RT |
| 7 | TiO₂ anatase - 2D (our | 62.97 | After 20 h in water and |
| (comparative) | try) with methanol | | irradiation, 3 bar of N₂, |
| | | | RT |

*this sample was analysed by XRD, UV-Vis and SEM

Reaction conditions for Table 1: the reactor (50 mL total volume) was filled with 20 mL of water and 5 mL methanol and 25 mg of photocatalyst (unless otherwise specified) and pressurised to 2 bar with dry N₂. Since overall water splitting can produce O₂, depending on conditions, the atmosphere should be an inert gas inside the reactor, to avoid miscalculations. The power of the lamp was 300 W and provided, at the current working distance, around 2 suns; we used an UV-Vis mirror module (˜250-650 nm). All the reactions were performed at room temperature (about 20° C.).

TABLE 2
Photocatalytic water splitting on TCO, reproducibility tests.

| | | H₂ production | | |
|---|---|---|---|---|
| Example | Photocatalyst | (micromol/gh) | Obs. | |
| 8 | Ti₃SiC₂-derived TCO | 199.24 | 5.5 | h |
| 9 | Ti₃SiC₂-derived TCO | 336.81 | 19 | h |
| 10 | Ti₃SiC₂-derived TCO | 569.39 | 35 | h |

Reaction conditions for Table 2: the reactor (50 mL) was filled with 20 mL of water and 5 mL methanol and 25 mg of photocatalyst and then pressurised to 2 bar with N₂. The power of the lamp was 300 W and provided, at the current working distance, around 2 suns; we used a UV-Vis mirror module (˜250-650 nm). All the reactions were performed at room temperature (about 20° C.).

In Table 2 it can be observed that TCO photocatalyst showed an increased tendency of H₂ production during time. Also, FIG. 4 depicts the cumulative H₂ yield for TCO during time. Same conditions were used 20 mL of water and 5 mL methanol, 25 mg of photocatalyst 3 bar with N₂. The power of the lamp was 300 W and provided, at the current working distance, around 2 suns; we used an UV-Vis mirror module (˜250-650 nm), at room temperature (about 20° C.).

### Additional Examples

Typical H₂ evolution results when one or two simulated suns were shone on Ti₃SiC₂-derived photcatalytic materials in 20 wt. % methanol/water mixtures, respectively, are shown in FIGS. 4-7. The one sun run was interrupted for 558 hours while a new lamp was acquired. The total time the flakes were in water was >800 hours, 280 hours of which were under illumination, the balance in the dark.

The photoactivity of all materials tested herein under two simulated suns are presented in Tables 3 and 4. The following are salient points:
i) All TCO photocatalytic materials, except the ones derived from TiO₂, produced H₂, while their 3D precursors were inactive. When TCO films were synthesized from commercial TiC powders at 50° C. they produced ≈600 μmol g⁻¹ h⁻¹ of H₂. When TCO films were synthesized from commercial TiC powders at 80° C., the H₂ rate was 942 μmol g⁻¹ h⁻¹. The latter value was only obtained, however, after the suspension was diluted twice.
ii) The highest rate of H₂ production occurred in methanol/water mixtures; the lowest in pure water, with the glycerol/water mixture in between. Clearly, the rate was greatly increased in the presence of hole scavengers such as methanol or glycerol.
iii) At ≈4.5, the highest apparent quantum yield, AQY, was when the 2D precursor was Ti₃SiC₂ (Table 4). These values were roughly 4 times those obtained starting with Degussa's product known under the trade designation P25 under identical conditions (compare 4A and 8A in Table 3).
iv) Most importantly there was no reduction in H₂ production even after ≈5000 hours in water, 300 hours of which were under illumination. It thus appeared that our flakes comprised of NFs were thermodynamically stable in water under both illumination and stirring. Given the cross-sections of these NFs, this was somewhat surprising and unexpected.

The production of H₂ was greater for TiC-derived films than TiB₂-derived films. See Table 3, compare Examples 5AA, 6A, and 7A. It is worth noting here that the former was black, while the latter were grey.

TABLE 3
Hydrogen production rate under UV-vis. light
irradiation equivalent to two simulated suns.

| | 3D pre- | Hole | 2D | H₂ production | AQY |
|---|---|---|---|---|---|
| Example | cursor | scavenger | photocatalyst | (μmol g⁻¹ h⁻¹) | (%)^{b} |
| 1A | Ti₃SiC₂ | None | TCOI | 20 | 0.11 |
| 2A | TiO₂ | None | TCOII* | 0 | — |
| | anatase | | | | |
| 3A | TiC | None | TCOII | 9 | 0.05 |
| 4A | Ti₃SiC₂ | Methanol | TCOI | 808 | 4.54 |
| 5A | TiO₂ | Methanol | TCOII^{c} | 63 | 0.36 |
| | anatase | | | | |
| 5AA | TiB₂ | Methanol | TB2O | 296 | — |
| 6A | TiC | Methanol | TCOIII_50 | 598 | 3.40 |
| 7A | TiC | Methanol | TCOIII_80 | 942 | |
| 8A | P25‡ | Methanol | Anatase | 180 | 1.02 |
| 9A | Ti₃SiC₂ | Glycerol | TCOI | 315 | 1.79 |
| 10A | P25‡ | Glycerol | Anatase | 20 | 0.11 |

^{b}Apparent quantum yield was calculated assuming: AQY = 2 × moles of H₂ formed × Avogadro's number × 100/number of incident photons. Parameters used to calculate number of incident photons (5.3 × 10²⁰ s⁻¹) are: wavelength: 365 nm (XHQA365 high transmission band-pass filter), light intensity, 40.9 mW/cm², irradiated area: 1.96 cm²
^{c}3D nanoparticles made by same process, in which case no C is incorporated in the anatase since we form nanoparticles instead of 2D (which can be p-2D) flakes comprised of NFs.⁴
‡Obtained from Degussa.

TABLE 4
Hydrogen production rate under UV-Vis light irradiation^{a}

| | | | | Amount of H₂ | |
|---|---|---|---|---|---|
| | | Washing | | formation | |
| Example | Precursor | procedure | Photocatalyst | (μmol · g⁻¹ h⁻¹) | AQY (%)^{c} |
| 11A | Ti₃SiC₂ | ethanol | TCO1_EtOH | 20^{b} | n.d. |
| 12A | Ti₃SiC₂ | LiCl | TCO1_LiCl | 18^{b} | n.d. |
| 13A | TiO₂ anatase | ethanol | TiCO2 | 0^{b} | n.d. |
| 14A | TiC | ethanol | TiCO3 | 9^{b} | n.d. |
| 15A | Ti₃SiC₂ | No treatment | Ti₃SiC₂ | 0^{b} | n.d. |
| 16A | TiC | ethanol | TiCO3 | 0^{b} | n.d |
| 17A | TiO₂ P25 | No treatment | TiO₂ P25 | 0^{b} | n.d |
| 18A | Ti₃SiC₂ | ethanol | TiCO1_EtOH | 808^{a} | 4.54 |
| 19A | Ti₃SiC₂ | LiCl | TICO1_LiCl | 470^{a} | 2.67 |
| 20A | TiO₂ anatase | ethanol | TiCO2 | 63^{a} | 0.36 |
| 21A | TiC | ethanol | TiCO3 | 598^{a} | 3.40 |
| 22A | Ti₃SiC₂ | ethanol | TiCO1_EtOH | 315^{d} | 1.79 |
| 23A | TiO₂ P25 | No treatment | TiO₂ P25 | 20^{d} | 0.11 |
| 24A | Ti₃SiC₂ | No treatment | Ti₃SiC₂ | 15^{a} | 0.09 |
| 25A | TiO₂ P25 | No treatment | TiO₂ P25 | 180^{a} | 1.02 |
| 26A | TiO₂ anatase | No treatment | TiO₂ anatase | 0^{a} | 0 |
| 27A | TiC | No treatment | TiC | | 0 |
| 28A | Ti₃C₂Tₓ | No treatment | Ti₃C₂Tₓ | 0^{a} | 0 |

^{a}Reaction conditions: 25 mg of solid material dispersed in 25 mL of a mixture of deionized water and methanol in a volumetric ratio of 4:1; irradiation with a MAX-303 illuminator (Asahi Spectra) equipped with UV-Vis mirror module (300-650 nm); an irradiance of ~200 mW/cm²; room temperature (25° C.).
^{b}the amount of H₂ formed during the overall water splitting reaction.
^{c}Apparent quantum yield was calculated using the following equation: AQY = 2 × number of moles of H₂ formed × Avogadro's number × 100/number of incident photons. The parameters used to calculate the number of incident photons (5.3 × 10²⁰ s⁻¹): wavelength: 365 nm (XHQA365 high transmission band-pass filter), light intensity: 40.9 mW/cm², irradiated area: 1.96 cm²;
^{d}glycerol was used as hole scavenger, the same reaction conditions as in^{a}.

TABLE 5
HPRs at room temperature, RT, as a function of catalyst under UV-vis. light irradiation equivalent of 2
suns (200 mWcm − 2). Intensities listed in last column were used to calculate AQYs. Numbers in square
brackets show HPRs and their corresponding AQY values obtained under 1 sun irradiation (100 mWcm − 2).

| | | | | | Time in | | | | |
|---|---|---|---|---|---|---|---|---|---|
| | | | | | water/MeOH | | | | |
| | | | | | | Time | H₂ prod. | | |
| | | Processing | | | Total | under | rate | | Light |
| | Precursor | of TCOs | Washing | Photocatalyst | Time | Light | (μmol · g⁻¹ | AQY | intensity |
| Entry | Chem. | temp. (° C.) [symbol] | procedure | code | (day) | (h) | h⁻¹)^{b} | (%) [symbol] | (mWcm⁻²)^{d} |

TCO

| | | | | | | | | | |
|---|---|---|---|---|---|---|---|---|---|
| 1 | Ti₃SiC₂ | 50 | Ethanol | TCO1 | 180 | 60 | 808 | 4.6 | 40.9 |
| 2 | Ti₃SiC₂ | 50 | LiCl | TCO1a | 33 | 280 [280] | 470 [83] | 2.7 [1.07] | 40.9 |
| | | | | | | | | | 18.1 |
| 3 | TiC | 50 | Ethanol | TCO2 | 180 | 300 | 598 | 3.4 | 40.9 |
| 4 | TiC | 80 | Ethanol | TCO3 | 79 | 120 | 631 | 11.7 | 12.5 |
| 5 | TiC | 95 | Ethanol | TCO4 | 36 | 24 | 1,014 | 5.3 | 44.4 |
| 6 | TiB₂ | 80 | Ethanol | TB1 | 24 | 24 | 296 | 2.9 | 23.7 |
| 7 | TiO₂ | 80 | Ethanol | TO [symbol] | 20 | 20 | 63 | 0.4 | 40.9 |

Other Catalysts

| | | | | | | | | | |
|---|---|---|---|---|---|---|---|---|---|
| 8 | TiO₂ | — | NA | P25 | 0.5 | 12 | 180 | 1.02 | 40.9 |
| 9 | Ti₃SiC₂ | — | NA | Ti₃SiC₂ | 0.5 | 12 | 15 | 0.1 | 40.9 |
| 10 | TiC | — | NA | TiC | 0.5 | 12 | 0 | 0 | 40.9 |
| 11 | Ti₃C₂T [symbol] | — | NA | Ti₃SiC₂ | 0.5 | 12 | 0 | 0 | 40.9 |

[symbol]

indicates data missing or illegible when filed

TABLE 6
Hydrogen production rate in water as a function of catalyst under UVvis light
irradiation with intensities listed in column 5. See Table 5 for details

| | [symbol] D pre- | Hole | Photo- | Light Intensity | H₂ production | AQY |
|---|---|---|---|---|---|---|
| Enty | cursor | scavenger | catalyst | (mW cm⁻ [symbol] ) [symbol] | (μmol · g⁻¹ h⁻¹) | (%) |
| 1 | Ti₃SiC₂ | None | TCO1 | 40.9 | 20 | 0.1 |
| 2 | TiC | None | TCO2 | 40.9 | 9 | 0.05 |
| 3 | TiO₂ | None | P25‡ | 40.9 | 0 | 0 |

a Light intensity values - obtained by using the 365 nm band-pass filter - used to calculate AQY from Eq. 2,
AQY (%) = (2 × # moles of H₂ formed × N [symbol] × 100) [symbol] N [symbol]
‡Obtained from Evonik (previously Degussa). [symbol]
indicates data missing or illegible when filed

TABLE 7
Hydrogen production rates, HPRs, obtained under the equivalence of 2
suns as a function of total time in the dark. The AQYs at 365 nm are
listed in column 6. Total time, in days, these catalysts were held in
the dark in the H2O/MeOH mixtures is denoted in brackets in column 3.

| | Reaction | | Photo- | | Light | |
|---|---|---|---|---|---|---|
| | temp [symbol] | Time in | catalyst | HPR | intensity^{c} | AQY |
| Entry | (° C.) | H₂O/MeOH | code | (μmol · g⁻¹ h⁻¹)^{b} | (mWcm⁻²) | (%)^{d} |
| 1 | 50 | 14 h | TCO2 | 598 | 40.9 | 3.4 |
| | | (182 d) | | 2,400 | 44.4 | 12.6 |
| 2 | 80 | 6 h | TCO3 | 631 | 12.5 | 11.7 |
| | | (79 d) | | 611 | 12.5 | 11.3 |
| 3 | 95 | 6 h | TCO4 | 1,014 | 44.4 | 5.3 |
| | | (36 d) | | 677 | 29.5 | 5.5 |

Temperatures at which precursors were transformed into TCO.
^{b}Reaction conditions: 25 mg of solid material dispersed in 25 mL mixture of deionized H2O to MeOH mixtures in a 4:1 vol. ratio, respectively. Irradiation with a Xe-lamp (MAX-303 illuminator, Asahi Spectra, Japan) equipped with a UV-vis. mirror module (250-650 nm).
^{c}As multiple light bulbs were used in this study, the AQYs, was calculated according to Extended Data Eq. 1: Wavelength to calculate AQY according to Eq. 1 is 365 nm. Parameters used to calculate number of incident photons: wavelength: 365 nm (XHQA365 high transmission band-pass filter); area = 1.96 cm2. Light intensity measurements were performed weekly for all bulbs used in this study.
^{d}Light intensity values obtained by using the 365 nm band-pass filter, that were in turn was used to calculate AQY. [symbol]
indicates data missing or illegible when filed

TABLE 8
Comparison of photocatalytic hydrogen production rates of TCO
versus other photocatalysts. For details on TCOs see Table 5.

| | | HPR | | |
|---|---|---|---|---|
| | React. | μmol | | |
| Material | time (h) | g⁻ [symbol] h⁻ [symbol] | Efficiency [symbol] | Ref. |
| TCO1 | 280 | 808 | AQY [symbol] 4.6% (365 nm) | This |
| | | | | work |
| TCO2 | 4, [symbol] 68 | 2,400 | AQY [symbol] 12.6% (365 nm) | This |
| | | | | work |
| TCO3 | 720 | 611 | AQY [symbol] 11.3% (365 nm) | This |
| | | | | work |
| TCO4 | 864 | 677 | AQY [symbol] 5.5% (365 nm) | This |
| | | | | work |
| CoO [symbol] Rh [symbol] rO [symbol] / | 1, [symbol] 00 | [symbol] 5.5^{b} | AQY [symbol] 56% (365 nm) | [symbol] |
| SrTiO [symbol] Al | | | | |
| Cu [symbol] O | 1,000 | 4 | QE [symbol] 0.3% ( [symbol] 0-600 nm) | [symbol] |
| Rh [symbol] Cr [symbol] O [symbol] / | 4, [symbol] 20 | 46 [symbol] 0 | AQY [symbol] .5% (420-440 nm) | [symbol] |
| (G [symbol] Zn [symbol] )(N [symbol] O [symbol] ) | | | | [symbol] |
| CDots [symbol] C [symbol] N [symbol] | 4,800 | [symbol] 10 [symbol] | AQY [symbol] 16% (420 [symbol] 20 nm) | [symbol] |
| Pt [symbol] Co [symbol] g [symbol] C [symbol] N [symbol] | 510 | [symbol] | AQY: 0.3% (405 nm) | [symbol] |

^{a}QE - Quantum Efficiency, defined by number of reacted electrons/number of photons absorbed;
AQY - defined as number of reacted electrons/number of incident photons. [symbol]
indicates data missing or illegible when filed

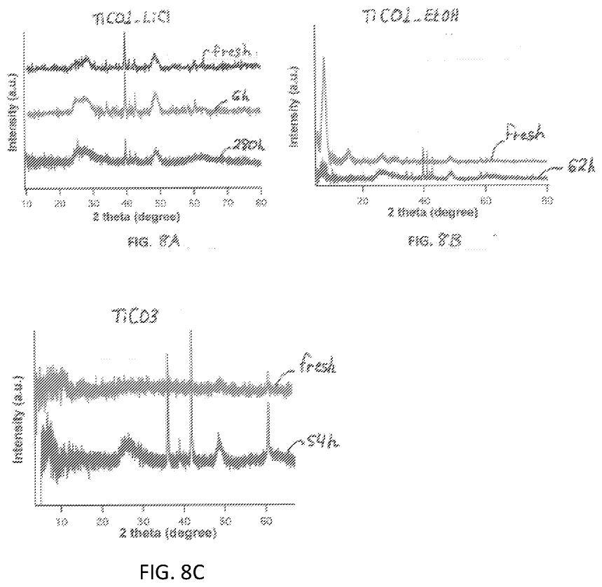

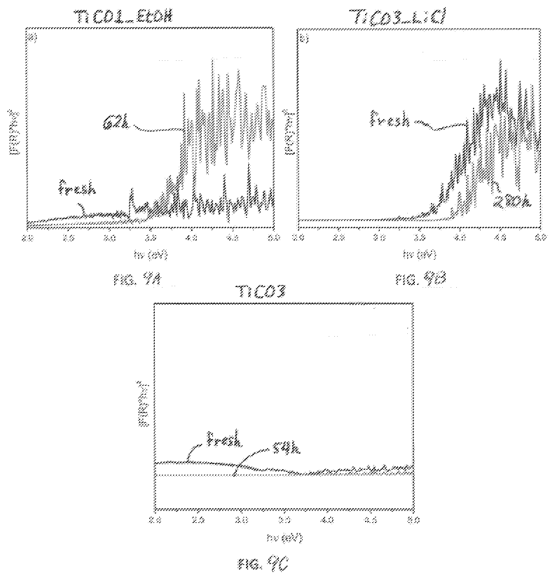

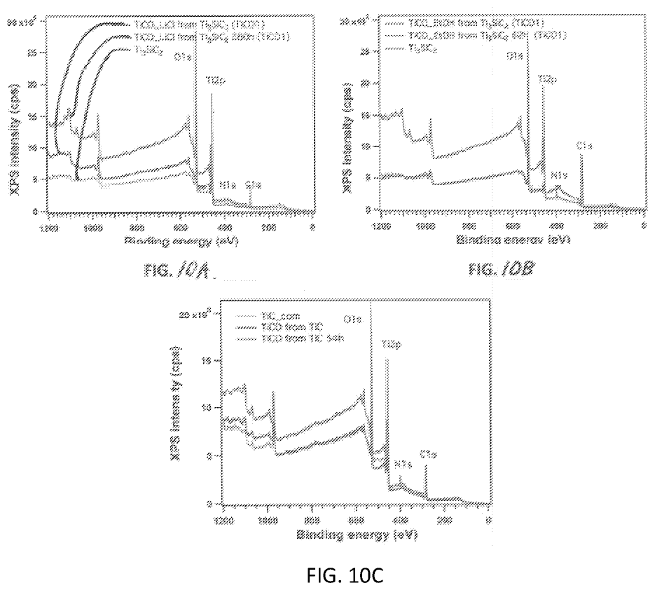

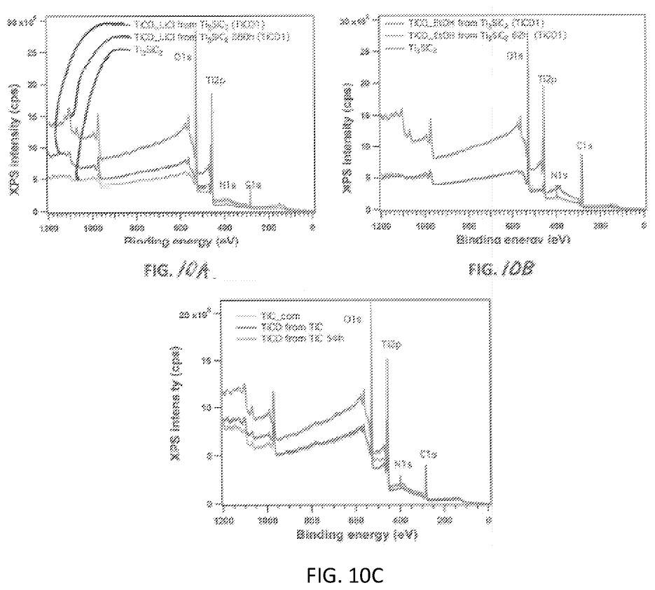

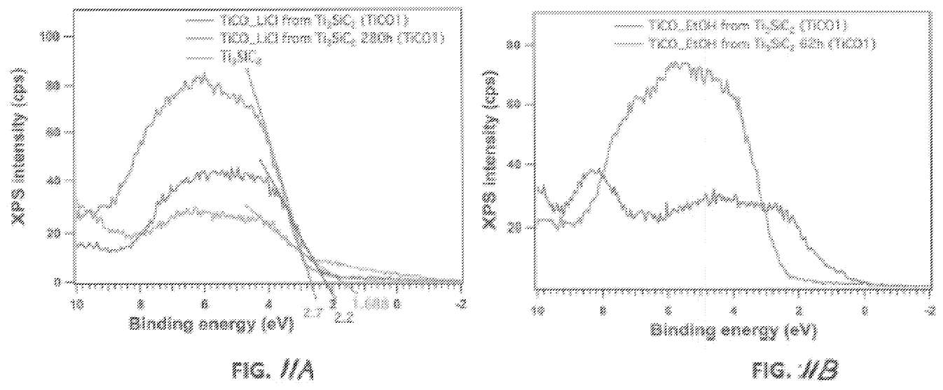

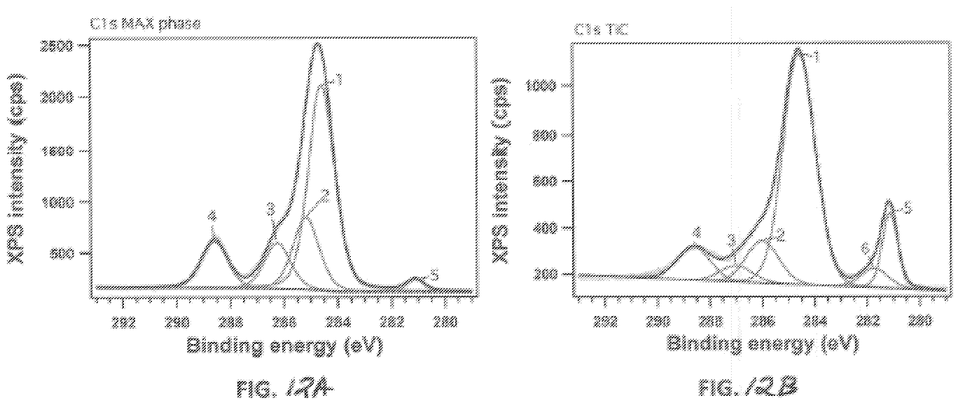

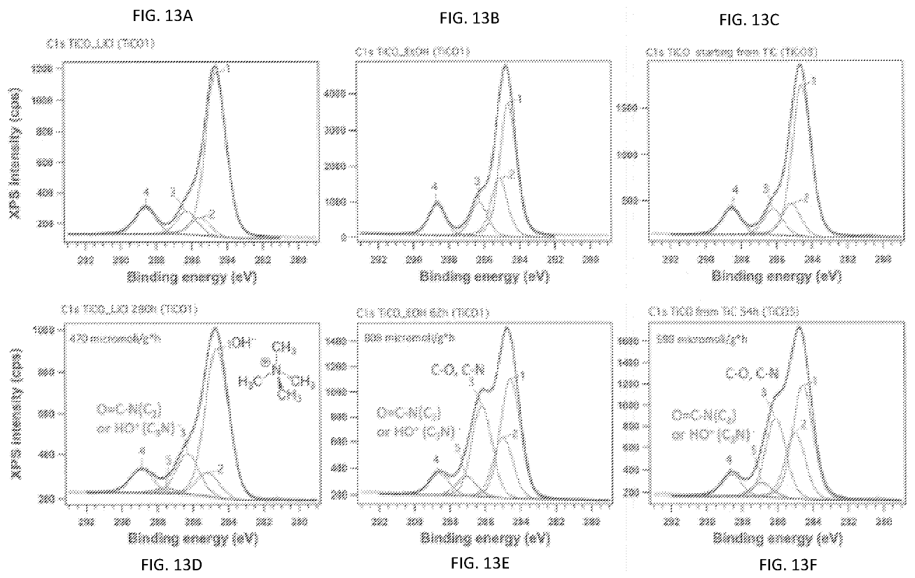

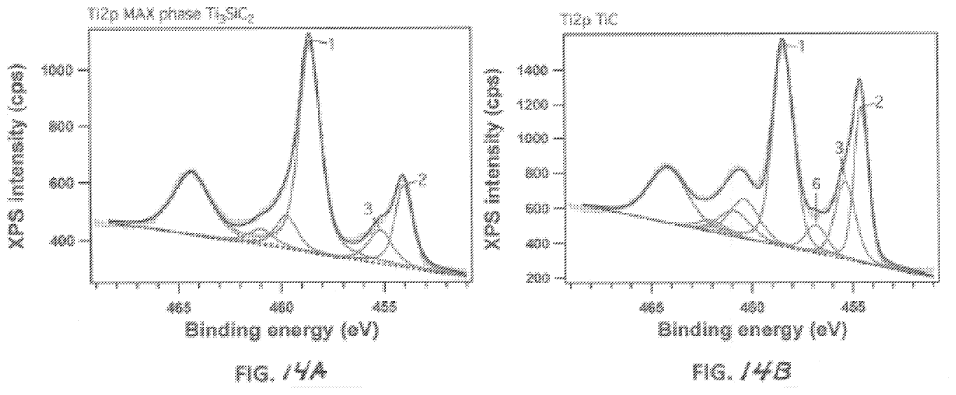

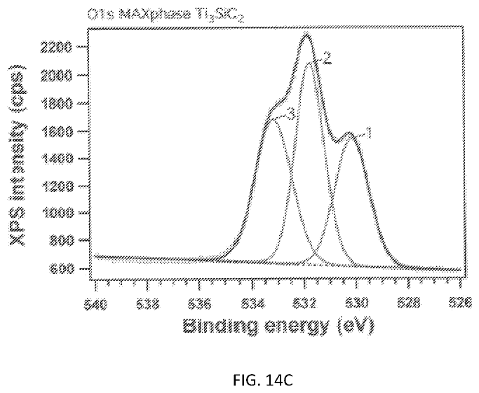

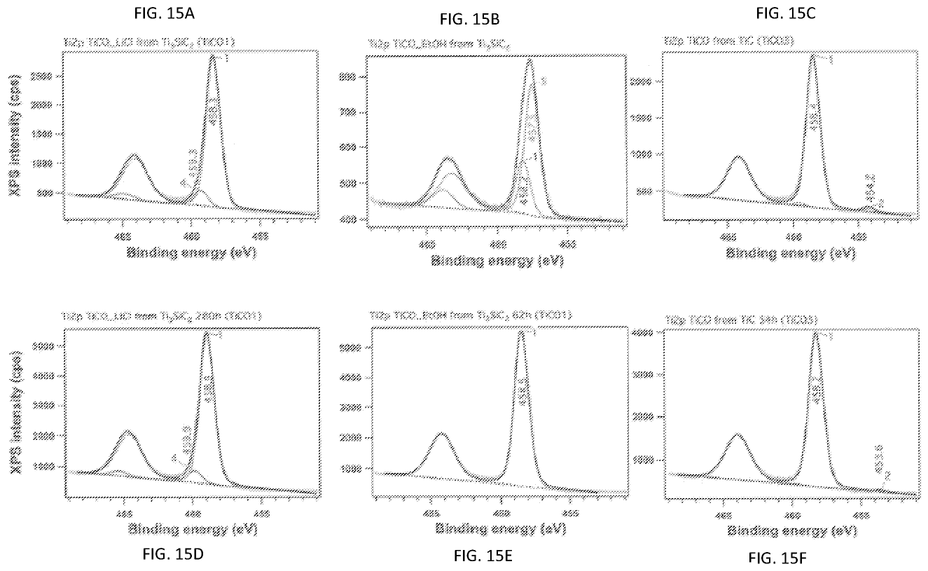

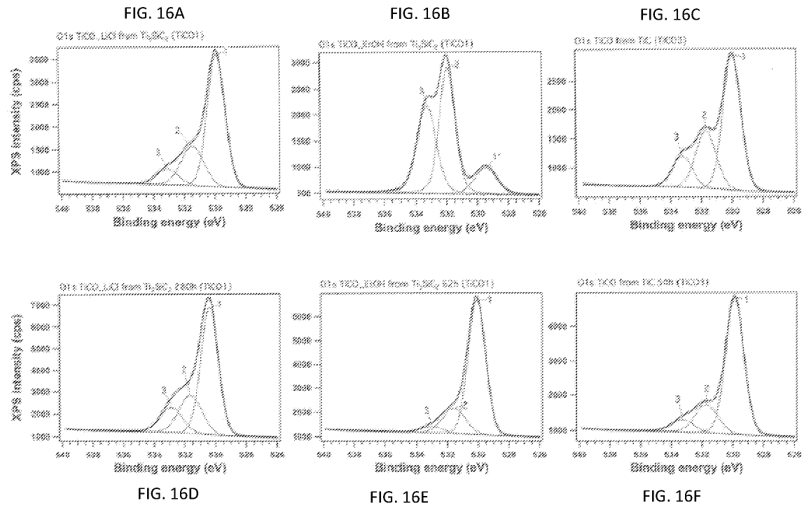

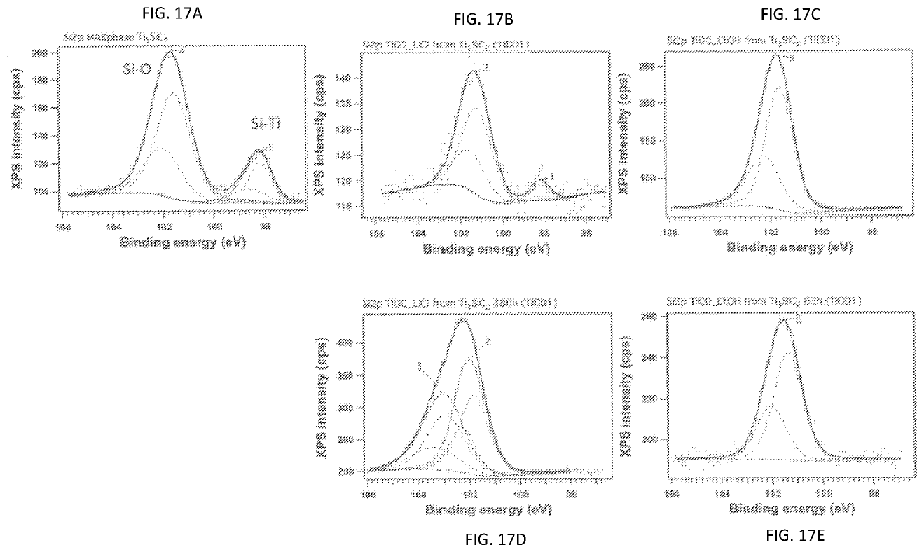

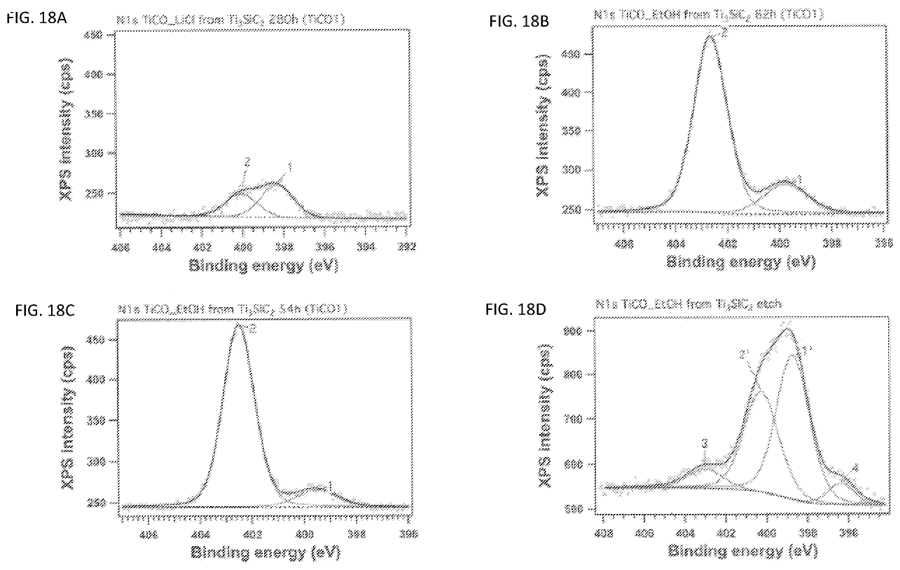

To confirm the stability of the flakes in water, we carried out a battery of tests before and after 280 hours of irradiation (800 hours total in water) on select TCO samples. X-ray diffraction, XRD, of the starting Ti₃SiC₂-derived flakes, before and after being illuminated for 280 hours, before and after 62 hours of illumination, and before and after 54 hours of illumination are shown in FIGS. 8A-C, respectively. From the results it is clear that, besides a possible broadening of the peak at 25° 20, there were no apparent changes in the XRD patterns. FIGS. 9A-9C plot typical Tauc plots before and after 280 hours of illumination, before and after 62 hours of illumination, and before and after 54 hours of illumination, respectively. FIGS. 10-18 plot XPS (x-ray photoelectron spectroscopy) results for TCO-derived photocatalysts from different precursors before and after H₂ production reaction. For instance, FIG. 10A plots the XPS results of Ti₃SiC₂-derived material before, and after, 280 hours of illumination. In all cases if any changes occurred at all they were small.

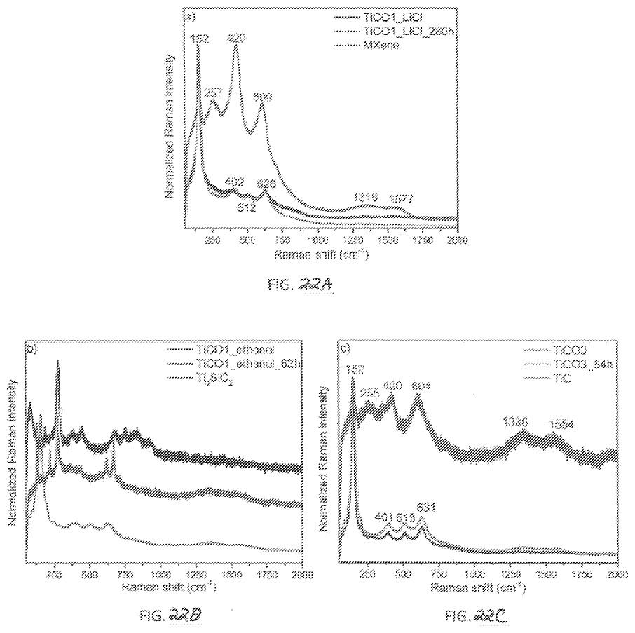

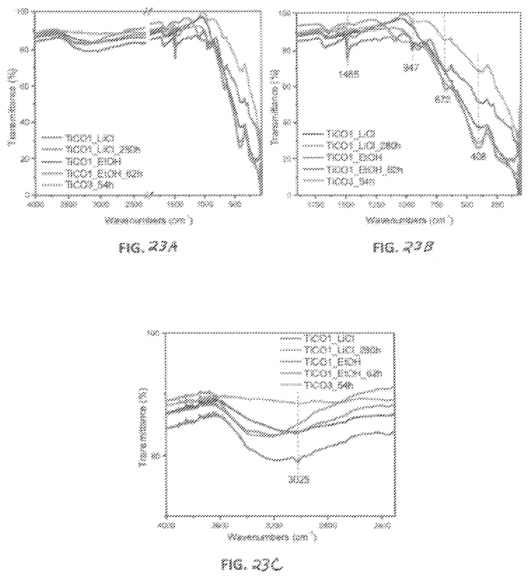

In all cases, there were no discernable or obvious changes, at least as measured by one or more of XRD (FIGS. 8A-C), Tauc plot, a measurement of band gap (FIGS. 9A-C), high-resolution XPS testing (FIGS. 10-18), Raman spectra (FIGS. 22A-C), and FTIR stretching vibrations (FIGS. 23A-C), after illumination for 280 hours. Based on the totality of the results it is fair to say that our TCO materials were quite stable in water for extended durations.

Experimentally, Tauc plots for our materials confirmed the presence of an indirect band gap at ≈4.1 eV that is independent of precursor chemistry. (Badr et al.) This band gap value was a record for TiO₂ and indirectly confirmed the (6×10 Å²) cross-section of our NFs. Density functional theory (DFT) analysis of 2D flakes' band structure also indicated a large ≈4 eV band gap as well as carbon states at mid-state or ≈2 eV above the VB (Badr et al.). When our TCOs were irradiated with a 2.5 eV laser, a photoluminescent peak at 2.1 eV was observed. The material was also black which we hypothesize was due to the presence of a large number of defects (Wang, X. et al., A metal-free polymeric photocatalyst for hydrogen production from water under visible light. Nature materials 8, 76-80 (2009); Badr et al.) Intriguingly, H₂ production dropped dramatically when the UV was filtered out. This implied that for unknown reasons, these localized states were not absorbing light and/or the e-h pairs generated were not participating in the photochemical process. This also implied that the enhanced H₂ production measured to date was most probably simply a surface area effect. This is especially true here since our band bap was almost 1 eV higher than Degussa's P25 and the theoretical surface area of our nanofilaments was >1500 m²/g.

Without being bound to any particular theory, this behavior may be related to monolayers from TiC derived film being anatase-based (though this is not a certainty or a necessarily even a requirement) and these layers, most probably, promoted the water splitting reaction. The highest H₂ evolution was recorded on MAX phase derived film, that was able to produce 808 μmol H₂ g⁻¹ h⁻¹, a quite high value as compared with others reported in the literature to date (See sample 4A at Table 3) or to TiO₂ P25 from Degussa (Table 1).

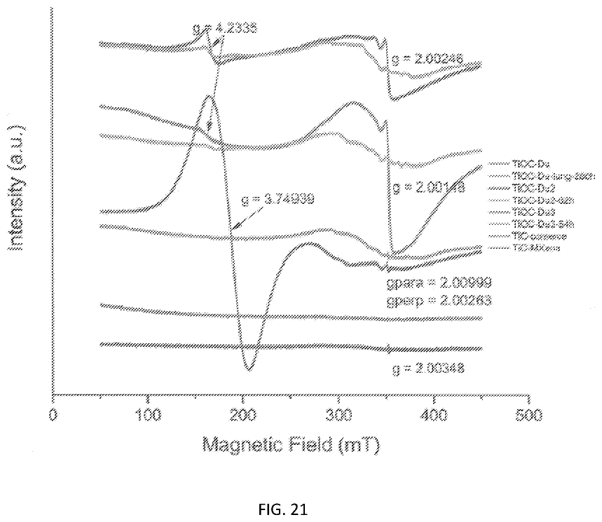

Higher exposed area, due to their 2D (which can be p-2D) feature, oxygen vacancies correlated with the presence of Ti³⁺, as revealed by EPR data (FIG. 21) and XPS data (see FIGS. 10A-C), presence of OH groups on the surface, may improve the adsorption of reactants and charge transport capabilities, that can efficiently suppress carrier recombination [Energy Environ. Sci., 2019, 12, 59], thus, increasing the photocatalytic efficiency. This was also the case when, hybrid materials containing TiO₂ nanosheets and graphene were used in water splitting, photocatalytic performance being facilitated by poorer photo-excited carriers' recombination and larger specific surface area. [Journal of Materials Science & Technology, 80 (2021) 171-178]

The photoactivity of the TiO₂ derived films was not so spectacular as for the other TCO samples, and this was mainly because this material was not layered, [Badr et al., Mater. Today], and therefore all the benefits related to this structural feature are not present.

It is worth noting that the washing step plays an important role in defining the features of these new TCO materials and therefore, different H₂ production rates were recorded (Table 1). The highest H₂ production was obtained for samples washed with ethanol. Without being bound to any particular theory or embodiment, one can theorize that washing with ethanol instead of LiCl delivered larger amount of carbon within the material structure and thus a much higher degree of disorder. Additionally, XPS data showed a higher amount of carbon at the surface of the materials washed with ethanol, and as consequence a component at lower binding energy for Ti 2p, which can be associated with Ti—O—C, was not observed for the same material washed with LiCl or for the TiC derived material. This component disappeared after reaction and Ti was found in a higher oxidation state (FIGS. 10-18). The higher activity and the presence of supplementary Ti—O—C carbon phase was correlated with DFT calculations which showed the appearance of a mid-state level with an energy of 2 eV within the bandgap when the C was inserted in the Ti—O structure.

It is well known that the presence of Ti³⁺ in TiO₂ semiconductors results in the formation of intrinsic co-catalytic centers and enhanced visible light absorption thus leading to higher photocatalytic activity. (See, for example, Chen, X. et al., Science (80-.)., 2011, 331, 746 LP-750; and Mohajernia S. et al., J. Mater. Chem. A, 2020, 8, 1432-1442). In our case the existence of Ti³⁺ and Ti²⁺ in our materials was confirmed by EPR analysis (FIG. 21), that indirectly indicated the formation of oxygen vacancies in 2D (which can be p-2D) derived films, that could easily explain the increased photoactivity of our samples and especially in the case of MAX phase derived films. Moreover, due to the 2D (which can be p-2D) structure of our systems, we assumed that the holes only must travel a short distance and recombination was less severe, thus playing a key role in the water splitting process. The presence of both types of centers (Ti³⁺ and Ti²⁺) is very important, since TiC derived film did not indicate the presence of Ti²⁺ and this sample was less active among the 2D (which can be p-2D) carbo-oxide films (FIG. 21).

In terms of AQY, the most active photocatalyst was TCOI_EtOH material (see Table 3 and 4), which reached an AQY of ca. 4.54% at 365 nm (Tables 3 and 4), being around 4 times more active than the well-known TiO₂ Degussa P25 photocatalyst.

### Water Splitting in the Presence of Glycerol as Hole Scavenger

Another way to produce H₂ through the photocatalytic water splitting reaction is to use low molecular weight polyols, such as diols, triols, and tetrols, or mixtures thereof, as hole scavenger. Using glycerol as an example, glycerol produces hydrogen in a half amount as compared with methanol, but with higher cost-efficiency advantages since glycerol is oversupplied as by-product from biodiesel. Additionally, the low toxicity of glycerol vs methanol makes it even a more interesting candidate for the water splitting reaction. Other useful low molecular weight polyols for producing H₂ photocatalytically include trimethylolpropane, pentaerythritol, and 1,4-butanediol. While the following discussion centers on use of glycerol, it will be understood by those skilled in the art that other low molecular weight polyols (MW less than about 200, especially less than about 150 g-mol⁻¹) and mixtures thereof are considered by the inventors herein as within the present disclosure for use as hole scavengers in the photocatalytic water splitting reaction to produce H₂.

### Long-Term Stability

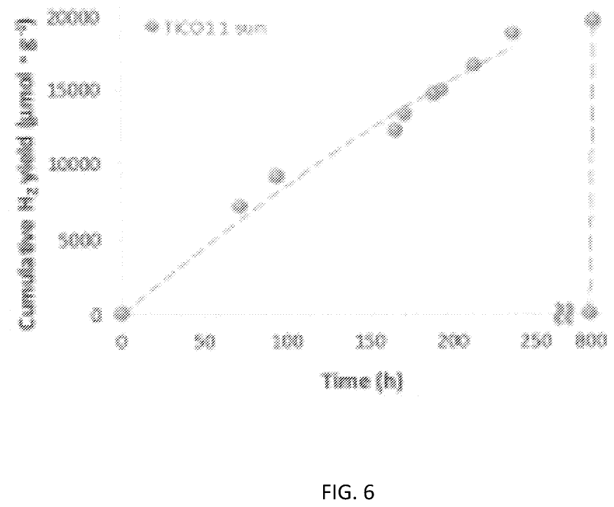

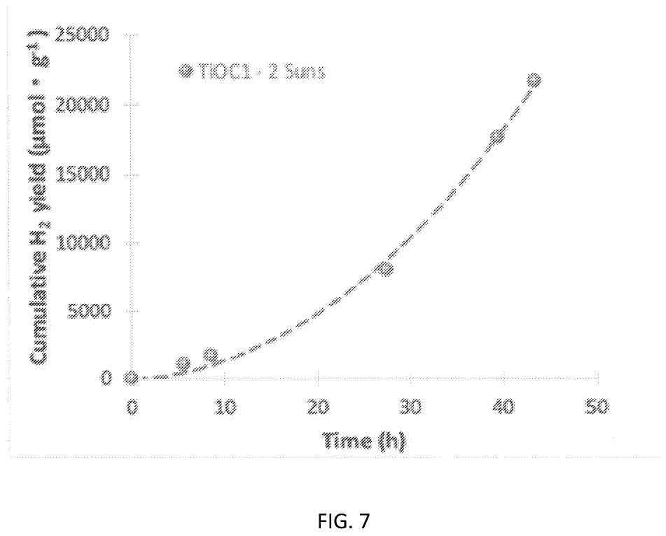

The long-term irradiation tests under two different irradiation conditions (one and two suns irradiance power) performed on the Ti₃SiC₂-derived materials (TCO1_LiCl sample-Table 3 and 4) revealed the unprecedented photocatalytic and thermodynamic stability of this material in water and under continuous irradiation and magnetic stirring conditions, respectively (FIGS. 6 and 7).

Ti₃SiC₂-derived material (TCO1_LiCl), under one sun irradiance, maintained its photoactivity even after 237 hours of continuous irradiation with (UV-vis) light. After these 237 hours, the reactor with the reaction mixture was closed and kept under dark conditions for an extra 558 hours (23 days) and after this interval, without any regeneration of the photocatalyst or any other operations, the reactor was irradiated for another 21 hours. As can be seen in FIG. 6, the photocatalyst was still active even after 800 hours (about 33 days) of immersion in the reaction mixture and a total irradiation time of 258 hours and the cumulative H₂ yield still showed an increasing tendency with almost the same H₂ production rate and a calculated AQY of ≈1.03% at 365 nm. This behavior revealed the unprecedented photocatalytic and thermodynamic stability of this material in water and under continuous irradiation and magnetically stirring conditions, respectively.

When the TiCO1_LiCl material was exposed to 2 suns (FIG. 7), the H₂ cumulative production yield sharply increased after ≈10 hours. Without being bound by any particular theory, we believe this behavior was caused by the H₂ evolution reaction itself, which is an activated process, and the increased number of photons absorbed on the surface of the photocatalyst, which in turn helped in the water splitting process. This result indicated once again that the Ti₃SiC₂-derived material (TCO1 in Tables 3 and 4) was a very stable photocatalyst, independent of the irradiance power of the used light source.

However, it is important to note that, due to the limited lifetimes of any commercially available irradiation source, only few studies in the literature report long irradiation time procedures. For example, to the best of our knowledge, Rh_{2-y}Cr_{y}O₃/GaN:ZnO was monitored for 180 days of irradiation time and for longer than 90 days, the reached AQY was calculated to be ca. 0.16% at 400-500 nm with no stirring conditions. (Ohno, T. et al., J. Am. Chem. Soc., 2012, 134, 8254-8259) (“Ohno et al.”). Even so, the complex structure deactivates and after 180 hours of irradiation time only 50% and 20% of the initial activity was retained under no stirring and under stirring procedure during reaction, respectively. The mechanical stirring process was found to be an important contributor to the deactivation process that occurs through the damaging of the photocatalyst surface, although it does not have a significant impact on photoactivity when the reaction proceeds for just several days. (Ohno et al.; see also Maeda, K., et al., J. Phys. Chem. B, 2006, 110, 13107-13112.) In our case, it appears that the stirring process did not have such a dramatic effect on the photoactivity (the calculated AQY being ca. 1.03% at 365 nm under a number of incident photons of ca. 2.35×10²⁰ s⁻¹) and the Ti₃SiC₂-derived material (TCO1 in Tables 3 and 4) was stable in time as shown by the characterization done before and after the catalytic testing, XRD patterns and Raman spectroscopy as presented further in FIGS. 8A-C and 22A-C, respectively.

In the meantime, most of the TiO₂-based materials start to degrade after 5 days, while the notorious “black titania” starts to degrade after 70 hours of irradiation (Chen, X. et al., Science (80-.)., 2011, 331, 746 LP-750), this pointing out the unique and unexpected qualities of our TCO type materials as the most stable photocatalyst for H₂ production discovered to date that we are aware of.

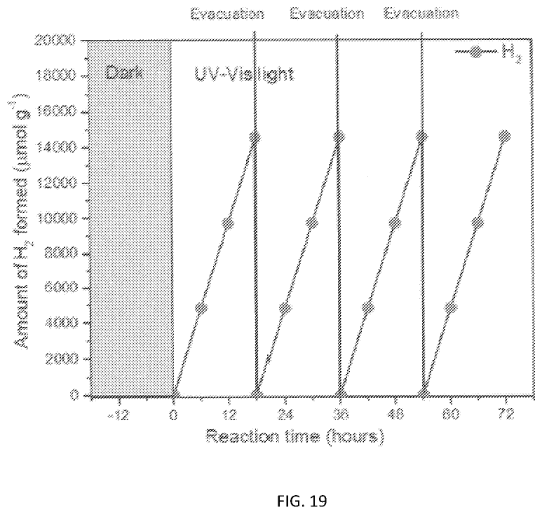

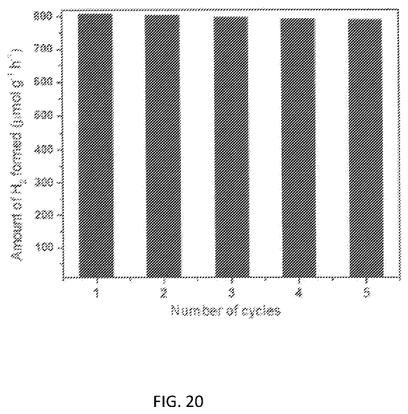

In addition, to support the previous stability statements, the time course and the cyclic tests for H₂ production through water splitting of Ti₃SiC₂-derived photocatalyst (TCO1 in Tables 3 and 4), under the same reaction conditions, are presented in FIGS. 19 and 20 and confirm its excellent stability with time on stream.

### Characterization of the 2D Carbo-Oxide Materials

The XRD patterns of the derived films before and after photocatalysis indicated that the structural features, characteristic to 2D (which can be p-2D) materials, were preserved after different reaction times for all the derived films (FIGS. 8A-C).

By applying the well-known Tauc plot method (Tauc, J., et al., Phys. status solidi, 1966, 15, 627-637) permitted us to find the band gap energy of our materials before and after the water splitting reaction. Thus, as shown in FIGS. 9A-C, Ti₃SiC₂ derived sample after washing with ethanol (TCO1_EtOH) photocatalyst, did not possess a bandgap, while after 62 hours of irradiation a bandgap energy of ˜3.5 eV was observed. This agreed with the valence band measurements from XPS analysis. (FIGS. 11A-B) The washing step played an important role, since, in the case of Ti₃SiC₂-derived material after LiCl washing (TCO1_LiCl in Tables 3 and 4) sample, before the reaction, a bandgap of about 3.5 eV was measured, while for upon 280 hours of irradiation the band gap increases to ˜3.9 eV (FIG. 9B) A possible explanation for the appearance/increases of the bandgap was that the photocatalytic reaction conditions lead to a decrease in particle size and thus a blueshift in the absorption spectrum.

The situation was different in the case of TiC-derived sample (TCO3 in Tables 3 and 4) which did not provide a bandgap before and even after the irradiation (FIG. 9C). This is in contradiction with the data obtained from XPS regarding the valence band that indicated the semiconductor behavior (see FIGS. 11A-B) but like in the case of TiCO1 EtOH before reaction, it can be explained by the higher degree of disorder and amorphicity (see FIGS. 8A-B). On the other hand, the Raman spectrum of TiCO3 showed (FIG. 22C) the formation of TiO₂ anatase, which might be responsible for the HER results.

Raman spectra taken after reaction for all TCO samples (see FIGS. 22A-C) showed peaks at 152 cm⁻¹, ˜400 cm⁻¹ and ˜512 cm⁻¹, which correspond to the E_{g}, B_{1g}, A_{1g} vibrational modes of anatase, respectively (Ohsaka, T. et al. Raman Spectrum of Anatase TiO₂. J. Raman Spec. 7, 321-324 (1978)). The peaks located at ˜630 cm⁻¹ and ˜1330 and ˜1550 cm⁻¹ could be attributed to C—Ti—C and graphitic C vibrations, respectively, as reported in the MXene literature (Sarycheva, A. & Gogotsi, Y. Raman Spectroscopy Analysis of the Structure and Surface Chemistry of Ti₃C₂Tₓ MXene. Chem. Mater. 32, 3480-3488 (2020)). Thus, the Raman spectroscopy confirmed that, independently of the precursors used for synthesis or the washing environment, the TCO samples were a combination of TiO₂ anatase and TiC-based materials.

In agreement with X-ray diffraction patterns, Raman data showed that in all cases, there was no significant structural modification after the performance of the photoreaction, which once again reinforces the idea that these materials are extremely stable in water and under irradiation.

### EPR (Electron Paramagnetic Resonance) Spectroscopy Results

The EPR spectra recorded in X-Band (9.87 GHZ) of the precursor materials and the derived TCO samples are presented in FIG. 21. The commercial TiC sample showed no paramagnetic centers at all. It has been reported that MXene has a very week isotropic signal with a g value of 2.0035 characteristic to the presence of some defects. (Scheibe, B., et al., Appl. Surf. Sci., 2019, 479, 216-224).

Conversely, the derived TCO samples showed very complex EPR signals (FIG. 21). First the TCO1_LiCl and TCO1_EtOH samples (Table 3 and 4) had a very intense sharp signal with g=2.00246 and g=2.00148, respectively, superimposed to a very broad signal, which could originate from Ti²⁺ ions with an electron spin S=1. We assigned the broad line to the (Ms=−1) to (Ms=0) and (Ms=0) to (Ms=±1) transitions and the sharp line to the (Ms=−1) to (Ms=±1) double-quantum transition which is not broadened by crystalline strains and imperfections, in first order. The same situation is encountered for a (3d⁸) ion in octahedral symmetry and Orton et al. (Phys. Rev. Letters 4 (1960) 128. Phys. Rev. 119 (1960) 1691) have conclusively demonstrated the double-quantum character of the sharp line occurring in the EPR-spectrum of the Ni²⁺ ion in MgO. TCO3 sample did not show this Ti²⁺ related signal; it only presented a very weak signal similar to the one observed for the MXene sample. In the lower field region, the TCO1 LiCl and TCO1_EtOH samples had an isotropic EPR resonance with a g-value of 4.23 characteristic for Fe³⁺ ions. This g-value is also encountered in the literature for Ti³⁺ and appears in TiC/C and TiN/C structures (Bodziony, T., et al., Characterization and EPR studies of TiC and TiN ceramics at room temperature, Mater. Sci.-Pol. 23 (4) (2005) 899-907). Sample TCO3 had a very characteristic low field EPR signal with a g-value (3.749) different from the other two samples that were analyzed that has not been reported yet in the literature. Since the previous measurements indicated a high presence of Ti³⁺ ions in the structure of this material, we tentatively associated this EPR signal to Ti³⁺ that are trapped in a highly symmetrical environment.

After irradiation, for TCO tested samples, the EPR signal intensities either dropped or disappeared entirely, as the X-Band spectra show, indicating that the main oxidation state of Ti ions was 4+, which is EPR silent.

### X-Ray Photoelectron Spectroscopy

From the XPS data, as general remarks, for the samples washed with ethanol, an increased amount of carbon on the surface was observed, most probably demonstrating a poor washing power compared with LiCl, which afforded a better ionic exchange with TMAOH. This was confirmed also by the FTIR data, see below. Another assumption could be that the Ti—O—C based materials had a stronger affinity for C. Interesting is the fact that after photocatalytic reaction/irradiation, all the materials had a similar surface with a lower C content, irrespective of the washing solvent.

It was also observed that after prolonged times (about 800 hours) in water and under irradiation (about 280 hours), the Ti is slightly oxidized, but this did not affect the photocatalytic activity of the materials. Moreover, after reaction, the TMAH observed in bulk (by ATR-FTIR) started to be visible by XPS at the surface, which make us believe that the TCO materials exfoliated more under stirring, the presence of water and under irradiation, bringing to the surface thin layers of bulk. Changes were also observed by UV-Vis. spectroscopy, where for TCO1_EtOH a larger bandgap was observed after reaction most probably due to the presence of smaller nanoparticles (blueshifting the absorption spectrum).

### Fourier-Transform Infrared Spectroscopy

The fresh and after reaction materials were investigated by ATR-FTIR (FIGS. 23A-C). The presence of TMAH was observed for all materials, except those washed with LiCl, confirming that the choice of the solvent for the washing step was important. Also, it should be underlined the presence of OH group in the TiCO materials. By exception TiC derived material did not present OH groups on the surface, however, this material present (TCO3) had a higher activity then TiO₂ Degussa P25.

In summary, we have shown in the present disclosure that 2D carbo-oxide layered materials were able to generate H₂ from water even in the absence of hole scavenger. These new materials meet the requirements of an efficient photocatalyst, such as effective charge separation, fast charge transfer, and the most important point, long-term stability in aqueous environments. The present results open new avenues for the exploration of energy production systems: 2D (which can be p-2D) carbo-oxide layered materials that are are cheap and commonly available, easily prepared by using a simple and low-cost scalable synthesis method.

The photoactivity could be related to the presence of reduced Ti oxidation state and implicit to the oxygen vacancies or/and to the presence of OH groups. However, TCO materials have very good activity and stability even after Ti oxidation or the absence of OH groups. Moreover, previous studies underlined the fact that stirring deactivated the photocatalytic materials after hundreds of hours, which was not the case here. of the light and decreases the recombination of charges.

### Experimental Details

### Photocatalytic Tests

For the performance of water splitting reaction, 25 mg of solid sample was immersed into a cylindrical quartz reactor (with a total volume of 55 mL) containing 25 mL of a mixture of water (known under the trade designation MILLI-Q, commercially available form MilliporeSigma) and methanol for a 4:1 volumetric ratio of water and methanol, respectively.

The suspensions were purged with dry nitrogen N₂ (99.999% nitrogen, available commercially from Linde under the trade designation 5.0 Linde) for at least 20 minutes and then the reactor was pressurized (2 bar) and irradiated for at least 5 hours with UV-Vis light (250-650 nm) provided by a photocatalytic setup, which was an Asahi Spectra high-power illuminator MAX-303 with a heat blocking design, 300 W xenon light source and UV-Vis mirror module, equipped with a one-meter-long quartz light guide and a collimator lens×1.0 (STD) Type RLQL80-1 that assured a uniform one sun illumination (an irradiance of 100 mW/cm²) at a working distance of 4 cm.

The gaseous samples taken from the outlet valve of the reactor were injected into a Shimadzu gas chromatograph, coupled on-line with the photocatalytic reactor, equipped with a TCD (thermal conductivity detector) detector for the quantification of H₂. Two serial-coupled GC columns, a column known under the trade designation MolSieve 5A (available from Agilent, Santa Clara, California, having column length of 30 m and ID of 0.32 mm) and a column known under the trade designation Rt-Q-Bond (available from Restek, Bellefonte, Pennsylvania, having column length of 30 m and ID of 0.53 mm) were used.

The GC calibration was carried out by injecting mixtures of H₂ in Ar (Linde) with known proportions. Several other blank experiments were performed in order to prove that the H₂ production originated from the device only. Reproducibility of the data was checked by performing independent experiments in duplicate, by which consistent results were obtained with significantly lower dispersions (smaller than 5%).

The temporal evolution of H₂ production over prolonged irradiation times was performed using the same setup, quantities of reaction mixture (25 mL of water known under the trade designation MILLIQ and methanol with a volumetric ratio of 4:1) and solid material (25 mg) and following the same procedure described above for the detection of evolved H₂ gas. After designated reaction times, the entire gas content of the reactor was injected into the GC for H₂ quantification and then the reactor was re-pressurized (2 bar) with dry N₂ and the reaction continued.

Typical procedure for photocatalytic tests. For the performance of water splitting reaction, 25 mg of solid TCO sample (made in accordance with co-pending International patent application number PCT/US2022/070644, filed Feb. 11, 2022) was immersed into a cylindrical quartz reactor (with a total volume of 55 mL) containing 25 mL of a mixture of MilliQ water and methanol in a 4:1 volumetric ratio respectively. The reactor was equipped with two gas valves and a pressure gauge. The suspensions were magnetically stirred (700 rpm) and purged with dry nitrogen (N₂ 5.0 Linde) for at least 20 minutes and then the reactor was pressurized (2 bar) and irradiated for at least 5 h with UV-vis. light (250-650 nm) provided by a photocatalytic setup. The latter was provided by an Asahi Spectra high-power illuminator MAX-303 with heat blocking design containing a 300 W xenon light source and a UV-vis. mirror module, equipped with a one-meter-long quartz light guide and a collimator lens×1.0 (STD) Type RLQL80-1 that assured a uniform 2 suns illumination (an irradiance of 200 mW/cm²) at the working distance of 8 cm. To perform the reactions at only 1 sun illumination (100 mW/cm²), the light intensity was adjusted by using the unit neutral density filter variable controller.

To perform the calculation of the AQY, we used the following: a band-pass filter (XHQA365, Asahi Spectra) and an optical power and energy meter console (PM100D Thorlabs, Germany) equipped with a high-resolution thermal power sensor (S401C, Thorlabs, Germany).

The gaseous samples taken from the outlet valve of the reactor were injected into a gas chromatograph (Shimadzu), coupled on line with the photocatalytic reactor, equipped with a TCD detector for the quantification of hydrogen, as explained previously herein. The temporal evolution of H₂ production over long-time irradiation time was performed using the same setup, as also explained previously herein. To perform cyclic testing, after each 14 h of reaction, the photocatalyst was recovered by vacuum filtration and was then reintroduced inside the reactor for the next cycle. Each cycle supposes the use of the same reaction conditions already specified above.

The X-ray diffraction (XRD) measurements were performed using a diffractometer known under the trade designation Bruker-AXS D8 Advance equipped with a detector known under the trade designation LynxEye 1D and Cu Kα (0.1541 nm) radiation source and a scintillation counter detector. The diffraction patterns were recorded at an 2θ angle in the range of 9-90°, with a step size of 0.02° and a rate of 1.2° min⁻¹. For the identification of the XRD phases present in the samples, the Powder Diffraction File from the International Centre for Diffraction Data (PDFICDD) was used.

The UV-Vis spectroscopy in diffuse reflectance mode (DR-UV-Vis) measurements were performed on a spectrophotometer known under the trade designation Lambda 45 (available from PerkinElmer) equipped with a RSA-PE-20 integration sphere. All DR-UV-Vis spectra were recorded under ambient conditions in the range between 200 and 700 nm by using BaSO₄ as baseline. The spectra were collected in reflectance units and were converted into Kubelka-Munk remission function F(R). Before each measurement, similar amounts of finely granulated samples and BaSO₄ were individually mixed and loaded in a quartz cell having windows made of high-purity synthetic fused silica known under the trade designation Suprasil. The band gap energy for direct allowed transitions was determined by finding the intercept of the straight line in the low-energy rise of a plot of [F(R)·hν]² against hν, where hv is the incident photon energy.

Raman spectra were recorded on in the range between 50 and 2000 cm⁻¹, using a spectrometer known under the trade designation LabRAM HR Evolution (available from HORIBA Jobin-Yvon) equipped with an air cooled CCD and the He—Ne laser with a wavelength of 633 nm. The spectra were recorded in the extended scan mode with acquisition time of 5×30 s.

The Fourier-transform infrared spectroscopy via attenuated total reflection mode (ATR-FTIR) in the mid-infrared region (4000-50 cm⁻¹) under vacuum conditions (−0.1 MPa) and at room temperature (ca. 22° C.) was performed with a spectrometer known under the trade designation Jasco 6800 equipped with a DLATGS (deuterated L-alanine triglycine sulfate) detector with Peltier temperature control and a single reflection ATR accessory (ATR-PRO670H-S from Jasco) having an anti-reflective coated diamond crystal plate and a flexible metal head, which provide a penetrating depth of around 1.66 μm. Each spectrum was obtained by averaging at least 80 scans at a 4 cm⁻¹ spectral resolution.

The electron paramagnetic resonance measurements were carried out on a continuous wave X-band spectrometer known under the trade designation EMX (available from Bruker) plus equipped with an X-band resonator known under the trade designation X-SHQ 4119HS-W1 (also available from Bruker). The measurement parameters for the X-Band measurements were set as follows: microwave frequency 9.877 GHz, microwave power 0.63 mW, modulation amplitude 0.2 mT, conversion time 20.02 ms, time constant 10.24 ms with 3 scans.

X-ray photoelectron spectroscopy (XPS) measurements were performed using a spectrometer known under the trade designation Ultra DLD (available from Kratos Analytical Ltd., a subsidiary of Shimadzu) setup using the Al Kα (1486.74 eV) radiation produced by an X-ray source operating at a total power of 300 W (12.0 kV×25 mA) and a vacuum of ˜1×10⁻⁴ MPa. The emitted photoelectrons were recorded by using a 165 mm radius hemispherical energy analyzer operated in fixed analyzer transmission mode with pass energy of 20 eV and magnetic immersion lens for enhancing the electron detection efficiency. Additionally, an electron flood gun operating at 1 eV electron energy and 0.1 mA current was used in order to compensate for charging effects of the sample. The above parameters were optimized in order to obtain the C Is peak of the adventitious carbon contamination of the sample at 284.60±0.05 eV. In extended XPS measurements, in order to get more information from sample's bulk, the surface of the materials was sputtered with a flux of Art ions. It should be noted that the sputtering process might create structural defects, which may have allowed the migration of the impurities embedded in the sample bulk toward the surface (Chirila C. et al. Effect of strain and stoichiometry on the ferroelectric and pyroelectric properties of the epitaxial Pb(Zr_{0.2}Ti_{0.8})O₃ films deposited on Si wafers. Mater. Sci. Eng. B 266, 115042 (2021)).

Each of the various process and composition embodiments can have one or more of the following additional elements in any combination:
Element 1: processes where the contacting of the 1D and/or 2D nanofilament-based photocatalyst (which can be carbon-doped or carbon-comprising) with water and a hole scavenger chemical and irradiating the catalyst, water, and the hole scavenger occur in a reactor;
Element 2: processes wherein the molecular hydrogen is devoid of CO, CO₂, and CH₄.
Element 3: processes wherein the contacting occurs under an inert gas purge.
Element 4: processes wherein the photocatalytic generation of molecular hydrogen produces from about 10 to about 200,000 micromoles of H₂ per hour per gram of the 1D and/or 2D nanofilament-based catalyst.
Element 5: processes wherein the hole scavenger chemical is selected from methanol, glycerol, and mixtures thereof.
Element 6: processes wherein the mole ratio of water to hole scavenger chemical ranges from about 2:1 to about 5:1.
Element 7: processes wherein step (a) occurs for times of at least about 10,000 hours.
Element 8: processes wherein step (b) occurs for time of at least about 300 hours under one sun illumination.
Element 9: processes wherein the hole scavenger chemical is methanol, and 800 μmol H₂ h⁻¹ per gram of the catalyst are produced under 2 suns illumination.
Element 10: processes wherein the hole scavenger chemical is glycerol, and 300 μmol H₂ h⁻¹ per gram of the catalyst are produced under 2 suns illumination.
Element 11: processes wherein no gases other than H₂ are generated.
Element 12: processes wherein the temperature ranges from about 10° C. to about 40° C.
Element 13: processes carried out at pressure ranging from about 1 bar to about 5 bar.
Element 14: processes wherein the irradiating is carried out for about 1 to about 300 hours.
Element 15: compositions prepared according to the processes.
Element 16: systems for carrying out the processes.

Although only a few exemplary embodiments of this disclosure have been described in detail above, those skilled in the art will readily appreciate that many modifications are possible in the exemplary embodiments without materially departing from the novel teachings and advantages of this disclosure, and these modifications are considered further Elements in accordance with the other embodiments. For example, the reactor vessels and processes described herein can be batch, semi-batch, continuous, or combination thereof in any particular embodiment (for example, a first batch reactor where photocatalyst material is produced, followed by a second reactor section where a second reactor is operated continuously to produce molecular hydrogen.) One, two, or more than two different reactors can be used in a photocatalytic reactor section (for example in parallel or series). Accordingly, all such modifications are intended to be included within the scope of this disclosure as defined in the following claims. In the claims, no clauses are intended to be in the means-plus-function format allowed by 35 U.S.C. § 112, Section F, unless “means for” is explicitly recited together with an associated function. “Means for” clauses are intended to cover the structures, materials, and/or acts described herein as performing the recited function and not only structural equivalents, but also equivalent structures.

### Aspects

The following Aspects are illustrative only and do not limit the scope of the present disclosure or the appended claims. Any part or parts of any one or more Aspects can be combined with any part or parts of any one or more other Aspects.

Aspect 1. A process for photocatalytically generating molecular hydrogen (H₂) comprising:
contacting a 1D and/or 2D (which can be p-2D) nanofilament-based photocatalyst, optionally carbon-doped or otherwise carbon-comprising, with water and a hole scavenger chemical at a mole ratio of water to hole scavenger chemical of from about 2:1 to about 6:1, optionally at a temperature less than about 100° C.; and
irradiating the photocatalyst, the water, and the hole scavenger chemical with at least one sun illumination (UV-Vis light (250-650 nm)), thus photocatalytically generating the molecular hydrogen.

It should be understood that although the photocatalyst materials can be carbon-doped or carbon-comprising, that is not a requirement. As described elsewhere herein, the photocatalyst materials can be, for example, 1D titania-based nanofibers that can self-assemble into pseudo-2D sheets (p-2D).

The illumination can be natural, but can also be synthetic. The process can be coupled to a storage vessel that stores the produced hydrogen. A storage vessel can be coupled to a fuel call that then operates using the stored hydrogen. Additionally and alternatively, the process can be coupled to a fuel cell that operates on hydrogen evolved from the process. A storage vessel can be part of or be coupled to a system according to the present disclosure. Likewise, a fuel cell can be part of or be coupled to a system according to the present disclosure. A fuel cell can be, for example, integrated into a vehicle. A fuel cell can also be integrated into a home or commercial electrical system, for example as a backup source of electricity.

Example photocatalyst materials are described in, for example, U.S. patent application No. 63/148,348, filed Feb. 11, 2021; U.S. patent application No. 63/167,197, filed Mar. 29, 2021; U.S. patent application No. 63/171,293, filed Apr. 6, 2021; U.S. patent application No. 63/275,631, filed Nov. 4, 2021; and Patent Cooperation Treaty application no. PCT/US2022/070644, filed Feb. 11, 2022. The foregoing applications are incorporated herein in their entireties for any and all purposes. As mentioned elsewhere herein, the photocatalyst materials can be anatase-based but need not be; the photocatalyst materials can also exhibit one or more anatase characteristics but need not necessarily do so. The photocatalyst materials can also exhibit one or more lepidocrocite characteristics, but need not necessarily do so.

The contacting can be performed at less than about 100 deg C., less than about 90 deg. C., less than about 80 deg. C., less than about 70 deg. C., less than about 60 deg. C., less than about 50 deg. C., less than about 40 deg. C., and all intermediate values and sub-ranges.

The illumination can be at about one sun, or even from about one sun to about five or even about ten suns of illumination. Illumination at from about one sun to about two suns is considered especially suitable, but is not a requirement.

Aspect 2. The process of claim 1 wherein steps (a) and step (b) occur in a reactor. Such a reactor can be transparent, but this is not a requirement.

Aspect 3. The process of claim 1 wherein the molecular hydrogen is free of CO, CO₂, and CH₄.

Aspect 4. The process of claim 1 wherein the contacting occurs under an inert gas purge. The inert gas can be, for example, nitrogen, a noble gas, and the like.

Aspect 5. The process of claim 1, wherein the photocatalytic generation of molecular hydrogen produces from about 10 to about 200,000 micromoles of H₂ per hour per gram of the 1D and/or 2D (which can be p-2D) nanofilament-based catalyst. The production can be, for example, from about 10 to about 200,000 micromoles per hour of micromoles of H₂ per hour per gram of the 1D and/or 2D (which can be p-2D) nanofilament-based catalyst, or from about 100 to about 150,000 micromoles of H₂ per hour per gram of the 1D and/or 2D nanofilament-based catalyst, or from about 500 to about 100,000 micromoles of H₂ per hour per gram of the 1D and/or 2D (which can be p-2D) nanofilament-based catalyst, or from about 1000 to about 75,000 micromoles of H₂ per hour per gram of the 1D and/or 2D (which can be p-2D) nanofilament-based catalyst, or from about 5000 to about 50,000 micromoles of H₂ per hour per gram of the 1D and/or 2D (which can be p-2D) nanofilament-based catalyst, or from about 10,000 to about 25,000 micromoles of H₂ per hour per gram of the 1D and/or 2D (which can be p-2D) nanofilament-based catalyst.

Aspect 6. The process of claim 1, wherein the hole scavenger chemical comprises an alcohol. Suitable alcohols include methanol, glycerol, and mixtures thereof. Other alcohols can also be used.

Aspect 7. The process of claim 1, wherein the mole ratio of water to hole scavenger chemical ranges from about 2:1 to about 5:1. The mole ratio can be, for example, from about 2:1 to about 5:1, or from about 2.5:1 to about 4.5:1, or from about 3:1 to about 4:1.

Aspect 8. The process of claim 1, wherein step (a) occurs for times of at least about 10,000 hours. For example, step (a) can last for from 10,000 to 100,000 hours. Step (a) can take place for less than about 100,000 hours, or even less than 10,000 hours.

Aspect 9. The process of claim 8, wherein step (b) occurs for time of at least about 300 hours under one sun illumination. Step (b) can take place, for example, for from about 300 to about 100,000 hours. Step (b) can also take place for less than 100,000 hours.

Aspect 10. The process of claim 5, wherein the hole scavenger chemical is methanol, and about 800 μmol H₂ h⁻¹ per gram of the catalyst is produced under 2 suns illumination.

Aspect 11. The process of claim 5, wherein the hole scavenger chemical is glycerol, and about 300 μmol H₂ h⁻¹ per gram of the catalyst are produced under 2 suns illumination.

Aspect 12. The process of claim 1 wherein no gases other than H₂ are generated. As an example, irradiating the photocatalyst, the water, and the hole scavenger chemical with at least one sun illumination (UV-Vis light (250-650 nm)) can photocatalytically generating a product that includes molecular hydrogen and is free of or essentially free of other gases.

Aspect 13. The process of claim 1 wherein the temperature ranges from about 10° C. to about 40° C. As an example, the 1D and/or 2D (which can be p-2D) nanofilament-based photocatalyst can be contacted with water and a hole scavenger chemical at a mole ratio of water to hole scavenger chemical of from about 2:1 to about 6:1 at from about 10 to about 40 deg. C.

Aspect 14. The process of claim 1, carried out at pressure ranging from about 1 bar to about 5 bar.

Aspect 15. The process of claim 1 wherein the irradiating is carried out for about 1 to about 300 hours.

Aspect 16. A composition prepared according to the process of any one of claims 1 to 15. Such a composition can include, for example, a 1D and/or 2D (which can be p-2D) nanofilament-based photocatalyst (as described elsewhere herein), water, and a hole scavenger chemical. The mole ratio of water to hole scavenger chemical can be from about 2:1 to about 6:1,

Aspect 17. A system configured to perform the process of any one of claims 1 to 15. Exemplary systems are described elsewhere herein.

1. A process for photocatalytically generating molecular hydrogen (H₂) comprising:
a. contacting a 1D and/or 2D nanofilament-based photocatalyst, optionally carbon-doped or carbon-comprising, with water and a hole scavenger chemical at a mole ratio of water to hole scavenger chemical of from about 2:1 to about 6:1, optionally at a temperature less than about 100° C.; and
b. irradiating the photocatalyst, the water, and the hole scavenger chemical with at least one sun illumination (UV-Vis light (250-650 nm)), thus photocatalytically generating the molecular hydrogen.

2. The process of claim 1 wherein steps (a) and step (b) occur in a reactor.

3. The process of claim 1 wherein the molecular hydrogen is devoid of CO, CO₂, and CH₄.

4. The process of claim 1 wherein the contacting occurs under an inert gas purge.

5. The process of claim 1, wherein the photocatalytic generation of molecular hydrogen produces from about 10 to about 200,000 micromoles of H₂ per hour per gram of the 1D and/or 2D carbon-doped nanofilament-based catalyst.

6. The process of claim 1, wherein the hole scavenger chemical comprises an alcohol.

7. The process of claim 1, wherein the mole ratio of water to hole scavenger chemical ranges from about 2:1 to about 5:1.

8. The process of claim 1, wherein step (a) occurs for times of at least about 10,000 hours.

9. The process of claim 8, wherein step (b) occurs for time of at least about 300 hours under one sun illumination.

10. The process of claim 5, wherein the hole scavenger chemical is methanol, and wherein about 800 μmol H₂ h⁻¹ per gram of the catalyst are produced under 2 suns illumination.

11. The process of claim 5, wherein the hole scavenger chemical is glycerol, and wherein about 300 μmol H₂ h⁻¹ per gram of the catalyst are produced under 2 suns illumination.

12. The process of claim 1 wherein no gases other than H₂ are generated.

13. The process of claim 1 wherein the temperature ranges from about 10° C. to about 40° C.

14. The process of claim 1 carried out at pressure ranging from about 1 bar to about 5 bar.

15. The process of claim 1 wherein the irradiating is carried out for about 1 to about 300 hours.

16. A composition prepared according to the process of claim 1.

17. A system for carrying out the process of claim 1.

18. The process of claim 1, wherein the photocatalyst exhibits one or more lepidocrocite characteristics.

19. A composition prepared according to the process of claim 18.

20. A system for carrying out the process of claim 18.
